(19) United States
(12) Patent Application Publication
(10) Pub. No.: US 2026/0274586 A1
(43) Pub. Date: Sep. 17, 2026

(54) FULLY AUTOMATED FACTORY FOR SOLAR PLANT

(71) Applicant: Terabase Energy, Inc., Berkeley, CA (US)

(72) Inventors: Grant Joseph Kimzey, Sacramento, CA (US); Adam Hansel, Davis, CA (US); Cedric Boss, Richmond, CA (US); Brian Coleman, Portland, OR (US); Soren Jensen, Corte Madera, CA (US)

(73) Assignee: Terabase Energy, Inc., Berkeley, CA (US)

(21) Appl. No.: 19/676,608

(22) Filed: May 13, 2026

Related U.S. Application Data
(63) Continuation-in-part of application No. 18/757,407, filed on Jun. 27, 2024.

(51) Int. Cl. B65G 47/04; B65G 37/02; B65G 43/08; H02S 20/32

(52) U.S. Cl. CPC B65G 47/04; B65G 37/02; B65G 43/08; H02S 20/32; B65G 2201/022; B65G 2203/0233; B65G 2203/042

(57) ABSTRACT

A large solar farm comprises one or more solar arrays, each with hundreds of rows of solar modules. Construction of a solar farm is a process that typically involves labor-intensive work that requires a large amount of human effort for solar table assembling and installation. The present invention discloses fully automatic factory embodiments to improve centralized solar table assembling efficiency for large solar plants. An automatic factory may comprise a panel conveyor, a torque tube dispenser, a table assembly station, a conveyor stage, and a table transfer stage for automatic solar table assembling, dispatching, and offloading. The application of the described embodiments may improve efficiency and safety for solar table assembling and solar table offloading from assembly line afterwards such that the overall construction process for large solar plants may be completed efficiently and safely with high quality.

### CROSS-REFERENCE TO RELATED APPLICATIONS

This application is a continuation-in-part of U.S. patent application Ser. No. 18/757,407 (Docket No. 20179-2708US), filed on Jun. 27, 2024, entitled “FULLY AUTOMATED FACTORY FOR SOLAR PLANT”, and listing Adam Hansel, Cedric Boss, Brian Coleman, and Soren Jensen as inventors. The aforementioned patent document is incorporated by reference herein in its entirety.

### TECHNICAL FIELD

The present disclosure relates generally to solar power plant installation. More particularly, the present disclosure relates to a fully automatic factory to improve centralized solar table assembling efficiency for large solar plants.

### BACKGROUND

The importance of solar power systems is well understood by one of skill in the art. Government agencies and companies are scaling the size and number of solar solutions within their energy infrastructure. This transition from traditional fossil fuel energy systems to solar energy solutions presents several challenges. One challenge is the ability to improve on-site installation efficiency, quality, and safety during the installation process of a large amount of solar modules. Such a process typically involves labor-intensive work that requires a large amount of human effort for solar table assembling and installation.

FIG. 1 shows a typical solar farm 105 comprising an array of installed solar structures 110, e.g., solar tables. Each solar structure comprises multiple solar modules 115. A large-scale solar farm typically includes hundreds of thousands of solar modules that are located across a multi-hundred-acre terrain and that are electrically coupled to provide a source of energy. In a typical installation process, multiple solar modules are securely aligned and attached to a metal structure (purlins or torque tube) to form a row of solar modules. A solar farm may comprise one or more solar arrays, with each solar array having hundreds of rows of solar modules. A row of solar modules may be supported by supporting structures (e.g., ground piles, ground screws, ballasted foundations, etc.) with the metal structure securely fastened to supporting structures at a desired rotational angle such that the solar modules are oriented for maximum energy production efficiency.

Large-scale systems are often located in remote areas and involve complex management of materials, resources, logistics, labor, etc. It is very desirable to improve installation efficiency, assembly quality, and safety during the installation process so that the overall construction process for large solar plants can be completed efficiently and safely with high quality.

What is needed are systems and methods that can effectively implement solar table assembly for improved efficiency, safety, and quality to facilitate large solar projects.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that the description is not intended to limit the scope of the invention to these particular embodiments. Items in the figures may be not to scale.

FIG. 1 depicts a general layout of a large-scale solar site.

FIG. 2A depicts a perspective view of an automatic factory for centralized solar table assembly according to various embodiments of the invention.

FIG. 2B depicts a perspective view of the automatic factory for centralized solar table assembly with the roof structure hidden according to various embodiments of the invention.

FIG. 3 depicts another perspective view of an automatic factory for centralized solar table assembly according to various embodiments of the invention.

FIG. 4 depicts a pallet conveyor as a panel conveyor loader in accordance with various embodiments of the invention.

FIG. 5A depicts a static pallet station as a panel conveyor in accordance with various embodiments of the invention.

FIG. 5B depicts a static pallet as a panel conveyor in the factory with the roof structure hidden in accordance with various embodiments of the invention.

FIG. 6A depicts a rotary table as a panel conveyor in accordance with various embodiments of the invention.

FIG. 6B depicts a rotary table as a panel conveyor in the factory with the roof structure hidden in accordance with various embodiments of the invention.

FIG. 7A depicts a perspective view of a torque tube with brackets in accordance with various embodiments of the invention.

FIG. 7B depicts a perspective view of a bracket in accordance with various embodiments of the invention.

FIG. 8 depicts an overview of a torque tube positioning system in accordance with various embodiments of the invention.

FIG. 9 graphically depicts a process for torque tube axial positioning in accordance with various embodiments of the invention.

FIG. 10A graphically depicts a process for torque tube orientation alignment in accordance with various embodiments of the invention.

FIG. 10B graphically depicts alternative approaches for torque tube orientation alignment in accordance with various embodiments of the invention.

FIG. 11 graphically depicts a process for torque tube proceeding for bracket attachment in accordance with various embodiments of the invention.

FIGS. 12-14 graphically depict a process for automatic bracket installation onto a torque tube in accordance with various embodiments of the invention.

FIG. 15 depicts the installation of a solar module onto a torque tube in accordance with various embodiments of the invention.

FIG. 16A depicts a top-down view of the automatic solar table assembly process in accordance with various embodiments of the invention.

FIG. 16B depicts a front side view and a back side view of a solar module in accordance with various embodiments of the invention.

FIG. 17 graphically depicts a process for automatic solar table assembly in accordance with various embodiments of the invention.

FIG. 18 graphically depicts a process for automatic solar module feeding in accordance with various embodiments of the invention.

FIG. 19 depicts a process for automatic solar table assembly in accordance with various embodiments of the invention.

FIG. 20 depicts a perspective view of loading assembled solar tables onto table racks in accordance with various embodiments of the invention.

FIG. 21 depicts a process view of loading assembled solar tables onto table racks in accordance with various embodiments of the invention.

FIG. 22 depicts a perspective view of loading an assembled solar table onto a mobile vehicle for delivery in accordance with various embodiments of the invention.

FIG. 23A depicts a perspective view of a system for discharging assembled solar tables in accordance with various embodiments of the invention.

FIG. 23B depicts a perspective view of a solar table received and moved in a conveyor stage in accordance with various embodiments of the invention.

FIG. 24 depicts a perspective view of a conveyor stage comprising multiple conveyor sections in accordance with various embodiments of the invention.

FIG. 25 depicts a perspective view of a conveyor section in accordance with various embodiments of the invention.

FIG. 26 depicts a detailed view of a lock actuator in a conveyor section in accordance with various embodiments of the invention.

FIG. 27 depicts a perspective view of drive components of a conveyor section in accordance with various embodiments of the invention.

FIG. 28 depicts a perspective view of proximetry sensor arrangement of a conveyor stage in accordance with various embodiments of the invention.

FIG. 29 depicts a perspective view of a table transfer stage comprising multiple table transfer sections in accordance with various embodiments of the invention.

FIG. 30 depicts a detailed view of a torque tube holder on a table transfer rail for horizontal movement in accordance with various embodiments of the invention.

FIG. 31 depicts a detailed view of a torque tube holder on a sliding rail supported on a frame capable of vertical movement in accordance with various embodiments of the invention.

FIG. 32 depicts a detailed view of a torque tube holder in a third table transfer section in accordance with various embodiments of the invention.

FIG. 33 graphically depicts a process of a torque tube holder holding a torque tube in accordance with various embodiments of the invention.

FIG. 34 graphically depicts a process of solar table transferring from a conveyor stage to a table transfer stage and movement within the table transfer stage in accordance with various embodiments of the invention.

FIG. 35 graphically depicts a process of solar table movement within the table transfer stage and solar table transferring from the table transfer stage to a mobile transport in accordance with various embodiments of the invention.

FIG. 36 depicts a process of offloading an assembled solar table from an assembly line in accordance with various embodiments of the invention.

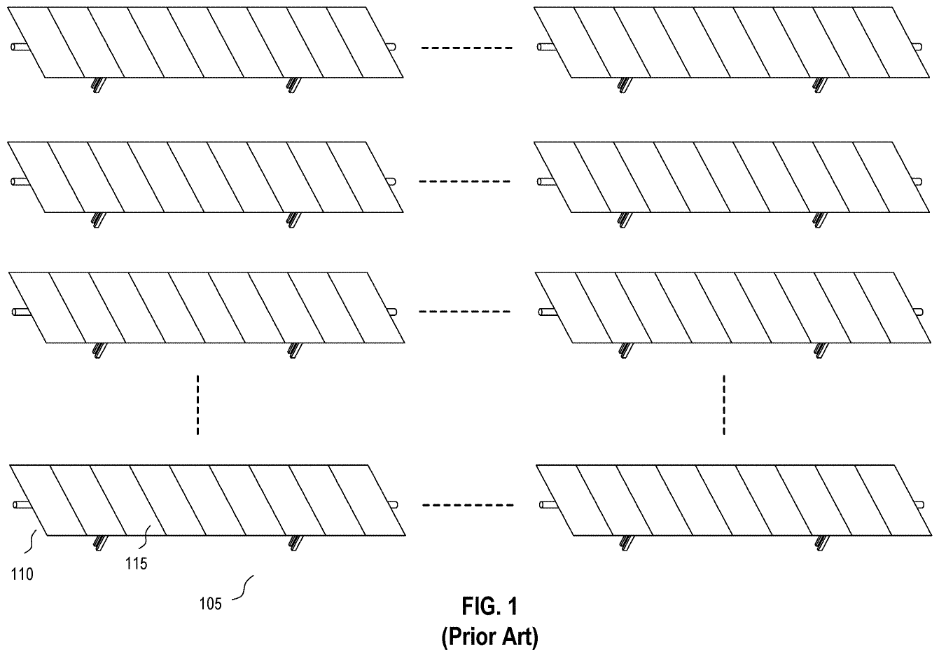

### DETAILED DESCRIPTION OF EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method.

Components, or features, shown in diagrams are illustrative of exemplary embodiments of the invention and are meant to avoid obscuring the invention. It shall also be understood that throughout this discussion components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components in a system for tracking and managing production, productivity, safety and quality on large projects, such as a construction of large-scale solar farm.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A component, function, or structure is not limited to a single component, function, or structure; usage of these terms may refer to a grouping of related components, functions, or structures, which may be integrated and/or discrete.

Further, it shall be noted that: (1) certain components or functionals may be optional; (2) components or functions may not be limited to the specific description set forth herein; (3) certain components or functions may be assembled/combined differently; and (4) certain functions may be performed concurrently or in sequence.

In this document, “large-scale solar system” or “large solar projects” is defined as a solar system or project involving installation and/or operation of 1000 or more solar modules. The word “resources” refers to material, parts, components, equipment or any other items used to construct a solar table and/or solar system. The term “solar table” is defined as a structural assembly comprising one or more photovoltaic (PV) or solar modules and/or one or more module frames (or purlins) for module support. Some types of solar tables may have electrical harnesses and supplemental structures that allow them to connect to other solar tables or foundations/piles while other types do not have this supplemental structure. The term “torque tube” is defined as a structural component that supports multiple solar modules with proper alignment. Torque tubes are often part of tracking systems for optimal sunlight capture for solar modules. The term “panel conveyor” is defined a section comprising an incoming section where full panel crates are lined up waiting to enter the second stage, a pick station where a robot picks panels from the crate/pallet/slipper and loads them on an inspection conveyor, and an outbound subsection where the empty crates, pallets/slippers are lining up waiting to get removed from the conveyor. The term “transport/landing vehicle” is defined as a specifically designed vehicle to transport solar tables from the centralized solar table assembly factory for on-site installation or on-site storage. The transport/landing vehicle may be driven by personnel, controlled by remote control, or autonomously driven by a computer system.

Traditionally, a distributed construction process is adopted for solar module installation. In such an installation process, all mounting equipment for each solar module is individually assembled and installed at its location within the larger system. Such traditional deployment relies on materials being delivered to a deployment site via an access road. The materials are then processed and staged at the deployment site by a crew. A small portion of this delivered material is then moved by heavy equipment to a specific location where a solar module and mounting equipment are assembled and installed at an installation location. The step is then repeated for an adjacent installation location where materials are subsequently delivered, assembled, and installed for a neighboring solar table within the system. For a large solar system, such an installation process becomes costly and has challenges of consistency and reliability over the entire installation process.

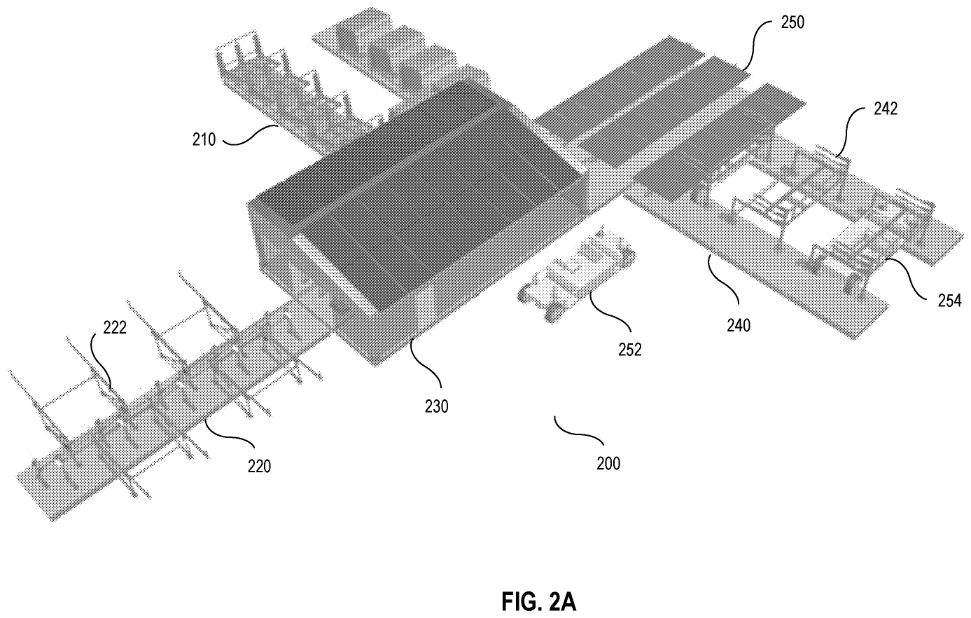

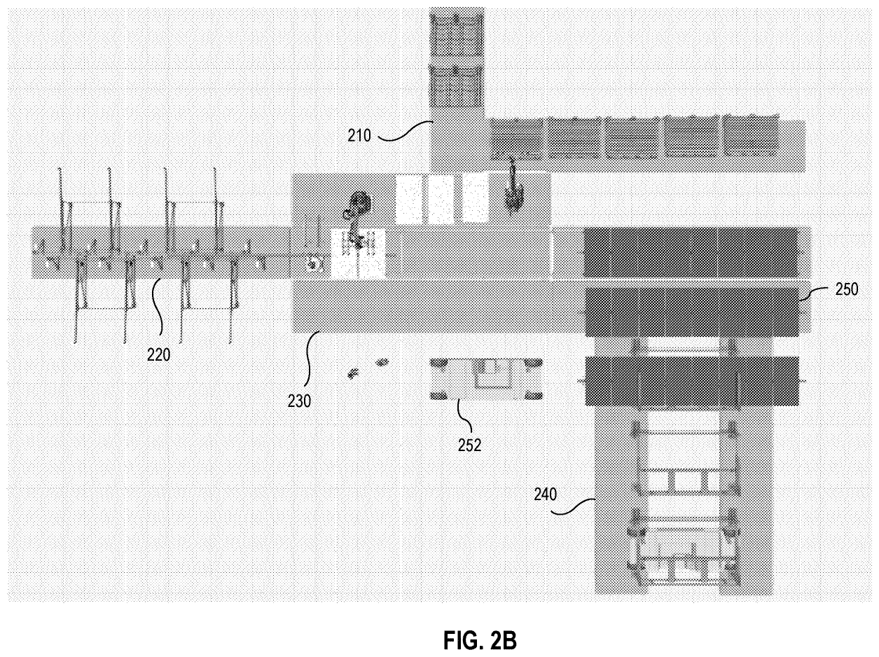

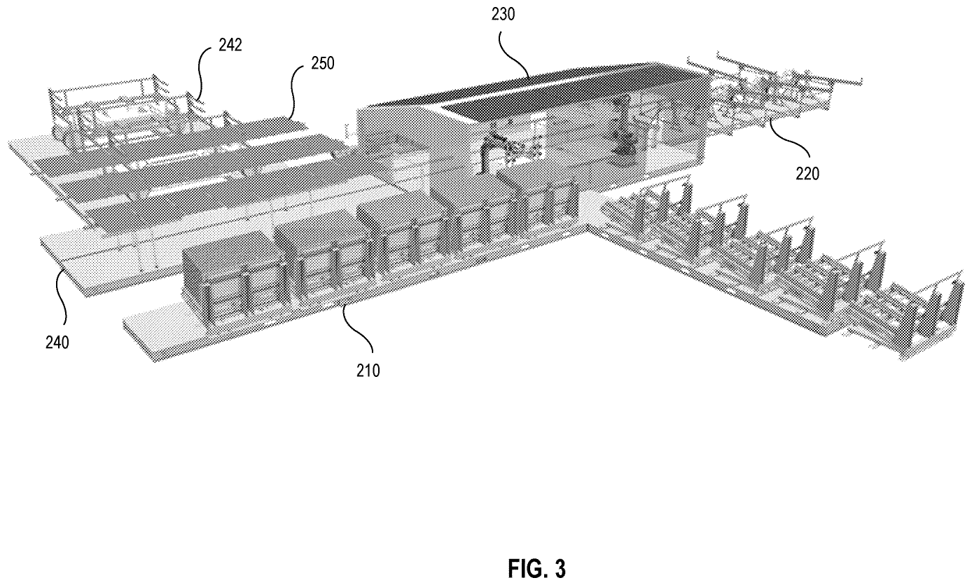

On the contrary, a centralized solar table assembly and installation may be implemented for large-scale solar systems. FIG. 2A, FIG. 2B, and FIG. 3 depict various perspective views of an automatic factory for centralized solar table assembly according to various embodiments of the invention. Resources, such as solar modules, torque tubes, mounting brackets, etc., are delivered to an automatic assembly factory 200 where a coordinated, automatic, and centralized solar table assembly process is performed. Assembled solar tables and equipment are moved from the factory 200 for on-site installation via motorized vehicles 252/254. The approach of utilizing a centralized and coordinated assembly factory may allow a more cost-effective and dynamic process of constructing large-scale solar systems.

As shown in FIG. 2A and FIG. 2B, the automatic assembly factory 200 comprises a module conveyor 210, a torque tube dispenser 220, a table assembly station 230, and a table delivery zone 240. The module 210 is a stage to receive solar module packs such that individual solar modules or solar modules are fetched from the module packs for solar table assembly. The torque tube dispenser 220 is a staging area comprising one or more dispenser station 222, where torque tubes may be loaded via telehandler and be fed into the table assembly station 230 for the production of solar tables. The table assembly station 230 is a station where solar modules and torque tubes are assembled together into solar tables 250. The assembled solar tables are then moved automatically to the table delivery zone 240 for delivery directly by motorized vehicles 252/254.

Embodiments of the fully automated factory allow more efficient distribution of material and better control of inventory with reduced labor hours. The throughput and build rate of solar farms are increased. By leveraging a fully automated process, much of the manual labor needed to move solar modules may be reduced or even eliminated. For example, assembly time for a solar table may be decreased in half from 4 minutes in a semi-automated factory to 2 minutes or less in a fully automated factory. Since the assembly operation is less dependent on operators, throughput is more stable and maintained with consistent assembly quality as long as the factory is continuously replenished with material, e.g., solar modules, torque tubes, brackets, mounting hardware, etc. Furthermore, by reducing or eliminating heavy manual labor for full table assembling automation, the assembling operation may run longer under environmental constraints (temperature, humidity, ventilation, noise level, etc.) that may typically be challenging for manual labor operation.

Described hereinafter are embodiments of various components of the automatic assembly factory 200. The embodiments may be applied in various combinations to implement automatic solar table assembly and delivery.

### A. Embodiments of Panel Conveyor

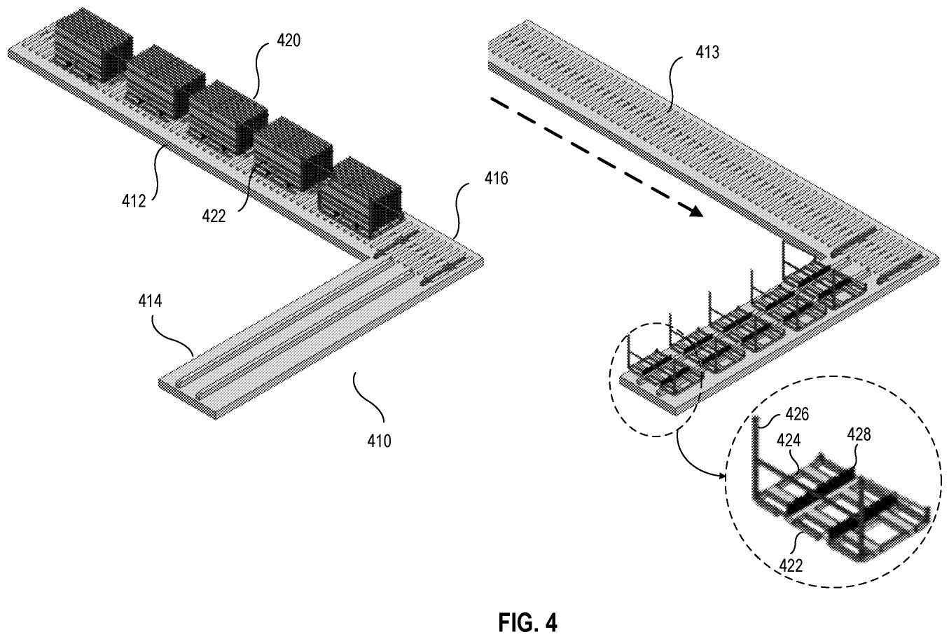

FIG. 4 depicts a pallet conveyor as a panel conveyor in accordance with various embodiments of the invention. Solar module pallets 420 are loaded onto slippers 422 for conveyance. The pallet conveyor 410 can be an L-shaped conveyor (or a U-shaped, or a linear conveyor) comprising a first section 412 to convey loaded slippers or module crates for table assembly and a second section 414 to dispatch empty slippers or empty crates. The pallet conveyor allows for the assembly factory 200 to operate automatically for an extended period without the need for re-loading of solar modules. The pallet conveyor 410 may comprise multiple rollers 413 (or a conveyor belt or similar conveyance) that are operated to automatically move in loaded slippers into a pick station 416 (which may be located at a proximal end of the first section 412) and move out empty slippers once the loaded slippers are depleted of modules.

The slipper 422 is an interface between the crate/pallet and the conveyor. The slipper 422 comprises a slipper base 424, a back support 426, and a pair of base supports 428 that are placed on the slipper base 424 for direct support of a module pallet 420. The slipper base 424 may be slanted slightly such that the module pallet 420 may lean against the back support 426 for pallet stability. The pair of base supports 428 may also comprise multiple grooves such that each solar module is supported on a corresponding groove. The pair of base supports 428 may be made of semi-rigid or elastic materials, such as rubber, to minimize impact to the module pallet 420.

In one or more embodiments, the pallet conveyor may have the capacity to hold multiple full slippers and multiple empty slippers, enabling longer “walk away time” and improving labor efficiencies for the logistics crew. When a slipper at the pick station 416 is emptied, the empty slipper and a newly loaded slipper may be moved simultaneously, reducing the awaiting time of the system and thus improving system dwell time and operation efficiency.

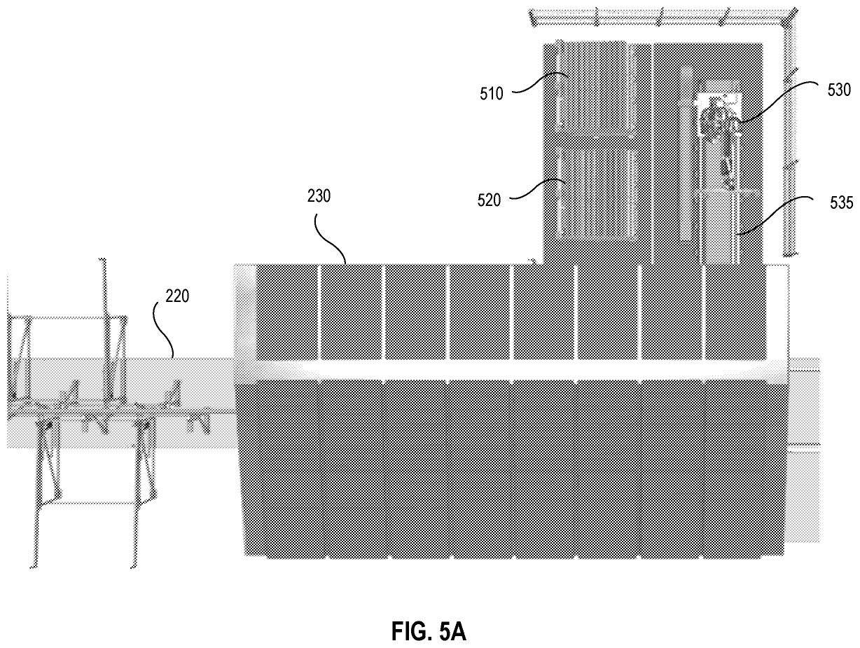

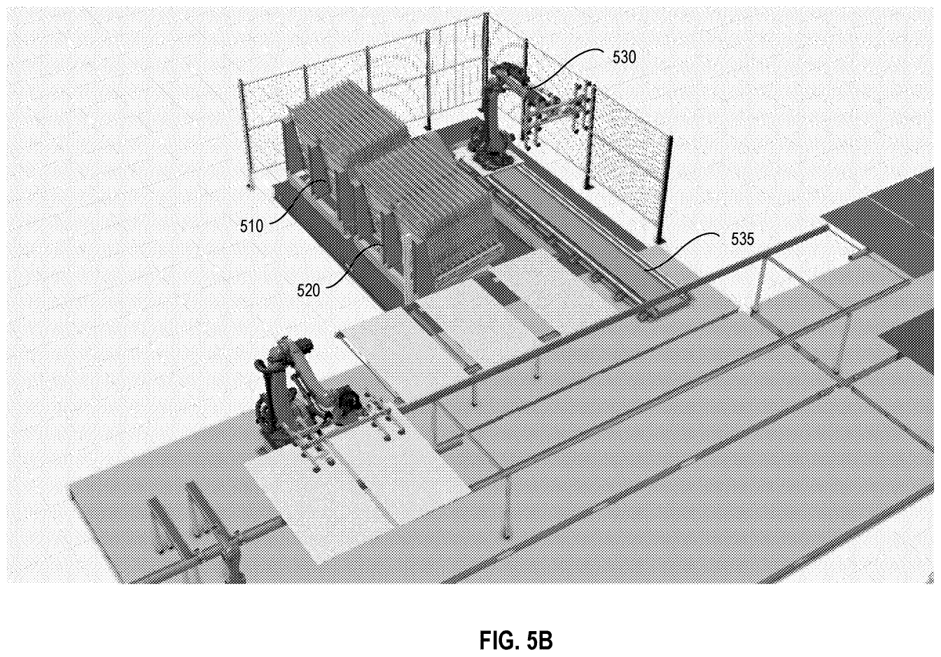

Instead of a pallet conveyor, a static pallet station may be used as a panel conveyor as shown in FIG. 5A and FIG. 5B. The static pallet station may comprise one or more pallet docks, e.g., a first dock 510 and a second dock 520, as shown in FIG. 5A and FIG. 5B, to receive loaded slippers. The term “dock” is defined as a place for loading of slippers with solar module pallets and unloading of solar modules from the pallets. A robot 530 deployed on a rail 530 may slide to a desired pick position to fetch a solar module from the slipper and deliver the fetched module to the table assembly station 230. The dual-dock configuration has a smaller footprint than the pallet conveyor shown in FIG. 4. It can still enable continuous module picking operation as long as the empty slipper is re-loaded while the robot 530 fetches solar modules from the other slipper. It shall be noted that although the robot 530 shown in FIG. 5B is deployed on the rail 535, the robot 530 may or may not need a rail dependent on the geometry and the reach of the robot.

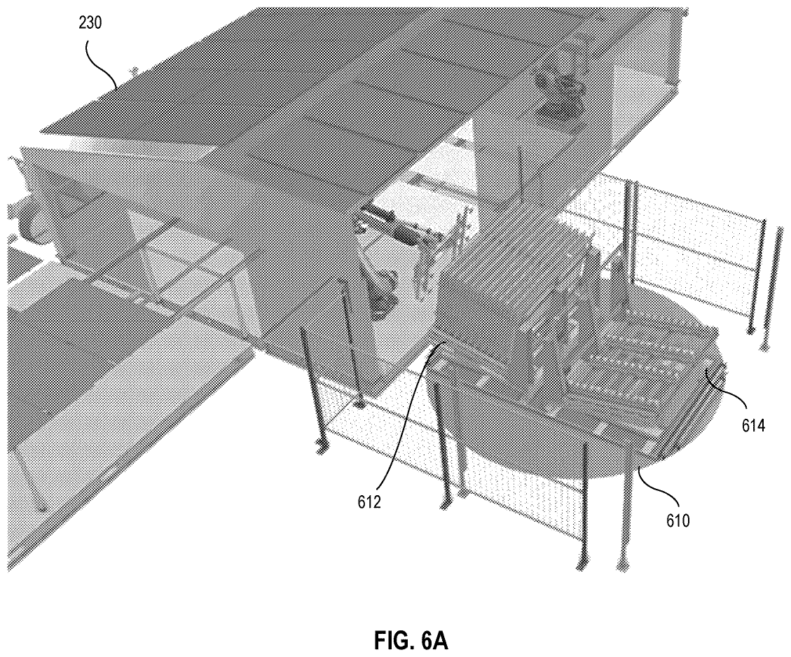

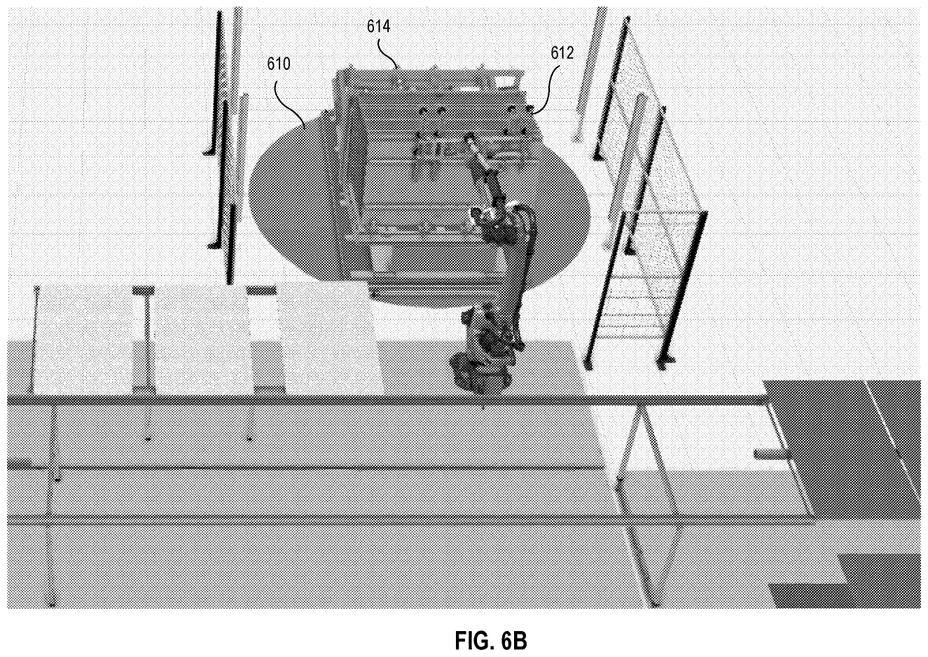

FIG. 6A depicts a rotary table as a panel conveyor and FIG. 6B depicts such a rotary table in a factory with roof structure hidden in accordance with various embodiments of the invention. Multiple slippers are placed on a rotary table 610 instead of docked side by side as shown in FIG. 5B. The rotary table 610 rotates to place a first slipper 612 with a full module pallet toward the assembly factory 200 for a robot to fetch solar modules. In the meantime, a second slipper 614 with an empty module pallet/crate/slipper is rotated away from the assembly factory 200. The second slipper 614 can be unloaded from the rotary table 610 and be replaced by a new slipper with a full module pallet. Therefore, module-loading operation may be continued without interruption. Compared to a pallet conveyor, the rotary table solution provides a smaller footprint but still maintains continuous production by slipper swapping. Although slippers are shown in embodiments in this section to provide an advantage for simplifying the interface between the crate/pallet and the conveyor, other embodiment may also be applied for loading the module crates directly on to the conveyor. The conveyor could have ramps with sloped surfaces keeping the modules from falling over. Such variations are included within the true spirit and scope of the present disclosure.

### B. Embodiments of Torque Tube Axial and Radial Positioning

Torque tubes are critical components in a solar tracking system. Torque tubes provide secure structural support for solar modules, and may be rotatable to ensure that all attached solar modules may be orientated to the Sun simultaneously for maximum photovoltaic operational efficiency. Torque tubes are typically circular, although other shapes, e.g., square, pentagonal, octagonal, or D in shape, may also be used.

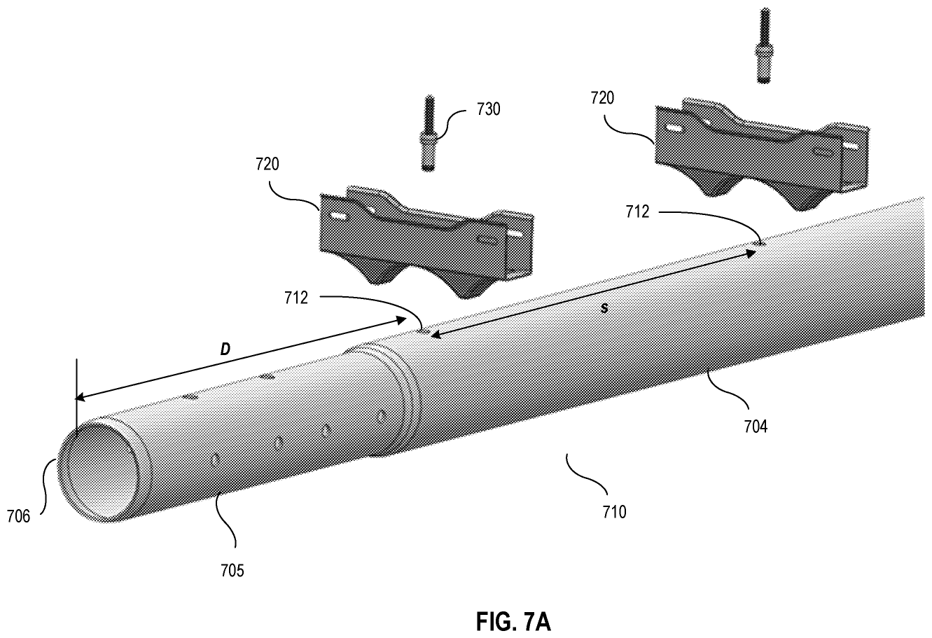

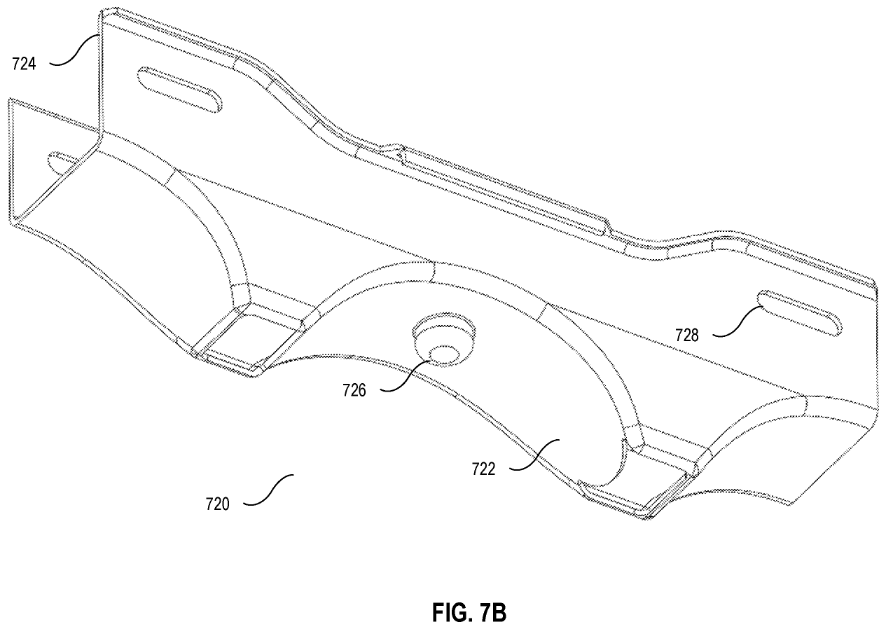

FIG. 7A depicts a perspective view of a torque tube with brackets in accordance with various embodiments of the invention. The torque tube 710 comprises a tube end 705 for tube installation on supporting piles and a tube body 704 that comprises multiple bracket holes 712 that are typically aligned and uniformly spaced (with a space s) for bracket installation. The tube end 705 is also referred to as a swaged end which has a dimeter different from the diameter of the tube body 704. The opposite end of the swaged end has the same diameter as the diameter of the tube body 704 and is referred as an unswaged end. The torque tube may have a known distance D (e.g., 644±7 mm) between a leading tube edge 706 and the nearest bracket hole (also referred to as a first bracket hole hereinafter) among the multiple bracket holes 712. Such a known distance D may be utilized for torque tube positioning.

A bracket 720, also referred to as a module interface bracket (MIB) in one or more embodiments of the present disclosure, may be securely attached to the torque tube 710 via a mounting component 730, e.g., a bolt, a screw, a rivet, etc. The bracket 720 is also the structure used to attach the rails or frames of a solar module for module installation.

FIG. 7B depicts a perspective view of a bracket in accordance with various embodiments of the invention. The bracket 720 comprises a concaved surface 722 that matches the torque tube for seamless contact, a grooved body 724 to receive purlins of a solar module. The grooved body 724 comprises multiple slots 728 for wedge locking. The concaved surface 722 may have a hole such that the mounting component 730, e.g., a bolt, a screw, a rivet, etc., may pass through to engage a bracket hole 712. Alternatively, the concaved surface 722 may have an anchor 726 to engage one bracket hole for alignment of bracket 720 onto the torque tube.

To enable automatic solar table assembly, the torque tube needs to be oriented to a desired angular position, e.g., with the multiple bracket holes facing upwards, for automatic MIB installation. Embodiments of torque tube axial and radial positioning are described hereinafter in details. The embodiments enable desired lengthwise and angular-wise movement for a torque tube for subsequent automatic installation of MIBs and solar modules. Although the bracket holes are facing upwards in embodiments of the present disclosure, one skilled in the art shall understand that the bracket holes may face other directions for alignment purpose. Such variations shall be within the true spirit and scope of the present disclosure.

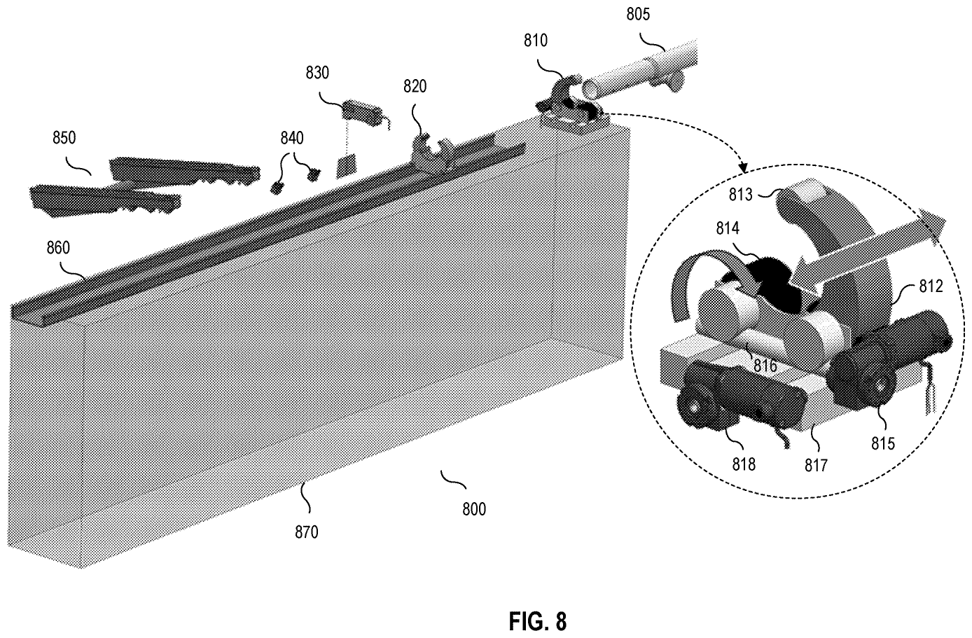

FIG. 8 depicts an overview of a torque tube positioning system in accordance with various embodiments of the invention. The torque tube positioning system 800 comprises a rotator 810, a tube clamp 820 (also referred to as an advance-clamp) slidably attached on a tube advance rail 860 that sits on a platform 870, a profiler 830, one or more proximity sensors 840, and a bracket station (also referred to as a MIB station) 850. The rotator 810 receives a torque tube 805, which is fed from the torque tube dispenser 220, and is configured to clamp the tube for micro axial direction (also referred to as north-south direction or N-S direction) and radial orientation alignment. As shown in FIG. 8, the rotator 810 comprises a clamp arm 812, a clamp roller 813 placed at a distal end of the clamp arm 812, a rotation wheel 814 for tube rotation, and a rotator base 817. The clamp arm 812 may be configured to be in an open position to let the torque tube 805 pass through, or in a closed position with the clamp roller 813 firmly pushing the torque tube 805 against the rotation wheel 814 to enable tube rotation. The rotation wheel 814 may be a worm wheel driven by a rotation motor 815 via a worm gear 816.

Furthermore, the clamp arm 812 and the rotation wheel 814 are slidably attached on the rotator base 817 such that the rotator 810 may also be capable of providing a relatively limited (e.g., 100 mm) but precise axial movement besides angular rotation (also referred to as clock positioning) for the torque tube while the clamp arm 812 is in the closed position.

In one or more embodiments, axial alignment may be implemented digitally. For example, the torque tube 805 is fed toward the profiler 830 with the first bracket hole within 100 mm of a nominal position. The profiler then determines the axial and longitudinal position of the first bracket hole. The axial position of the torque tube with the first bracket hole aligned on top is recorded as an aligned axial position. As the torque tube is moved, the actual axial position may be shifted from the aligned axial position. As the torque tube is progressing one module increment at a time, the profiler is detecting the first hole of the next set of bracket holes and is correcting the axial position shift accordingly. Such readjusting of the torque tube axial position may be a further refinement for automatic torque tube feeding, although it could be omitted in some embodiments.

The profiler 830 may be a laser profiler that emits a laser beam 832 (a visible laser or an infrared laser) onto the torque tube. The laser beam is reflected off the tube surface and captured by a sensor within the profiler to generate a profile. When the laser beam 832 falls into a bracket hole 712, the reflection is significantly different. Therefore, the laser profiler is able to precisely locate the bracket hole 712. Although a laser profiler is shown on some of the figures, one skilled in the art shall understand that other types of profilers, such as a camera-based or ultrasound profiler, may also be used for torque tube radial positioning.

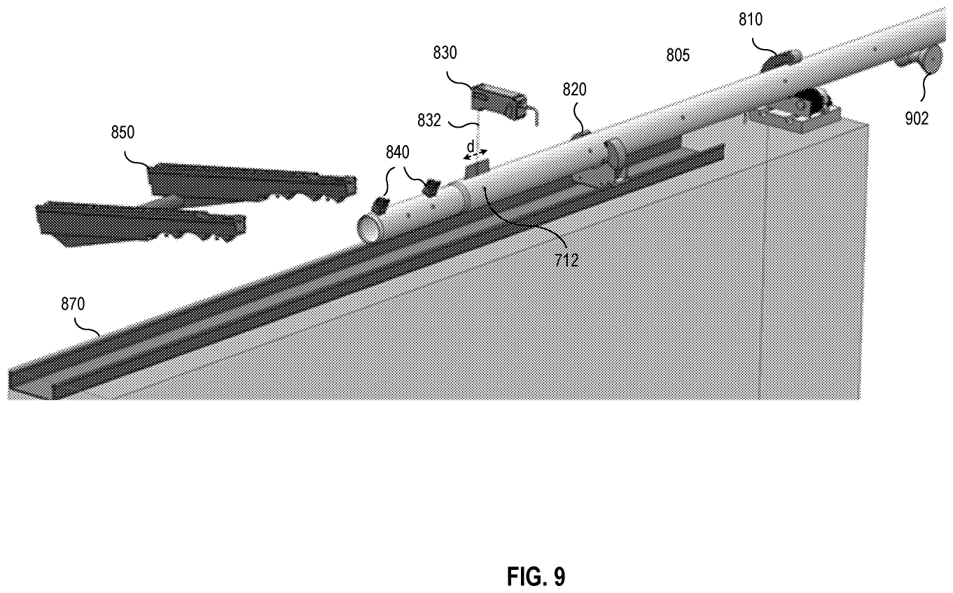

FIG. 9 graphically depicts a process for torque tube axial alignment in accordance with various embodiments of the invention. The torque tube 805 is first fed from the torque tube dispenser 220 by one or more feeding rollers 902 to partially pass through the rotator 810 and the tube clamp 820, as shown in FIG. 9. The one or more proximity sensors 840 indicate when to stop the one or more feeding rollers 902 such that the torque tube 805 may be stopped with the first bracket hole longitudinally within a scanning range d (e.g., 150 mm) of the profiler 830. For example, one proximity sensor 840 may be placed away from the profiler with a distance the same as the distance D. When this proximity sensor detects the torque tube, the sensor sends a signal to the rollers 902 such that the torque tube may be stopped at a first location where the first bracket hole longitudinally within the scanning range d, although the angular or clock position is unknown at this stage.

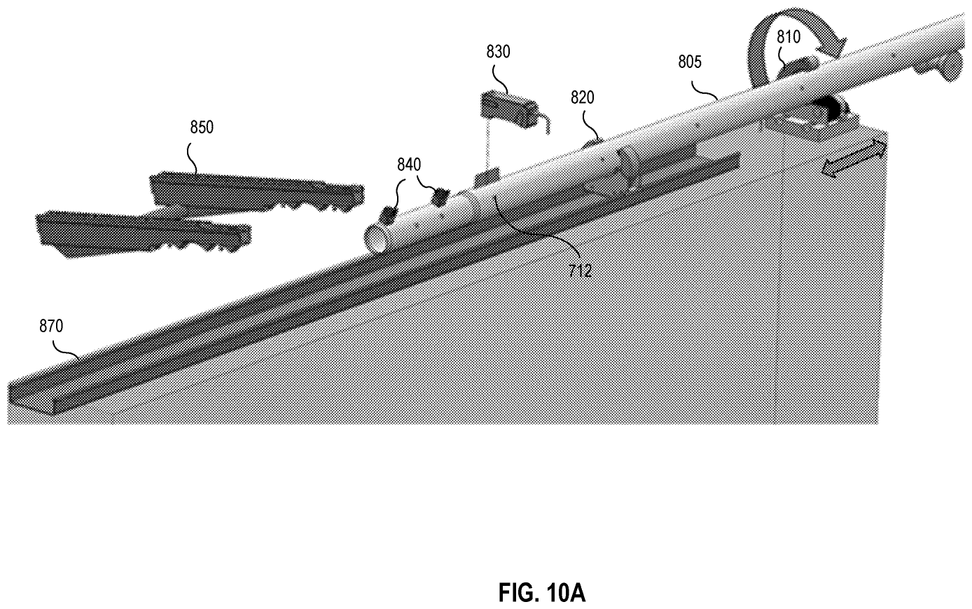

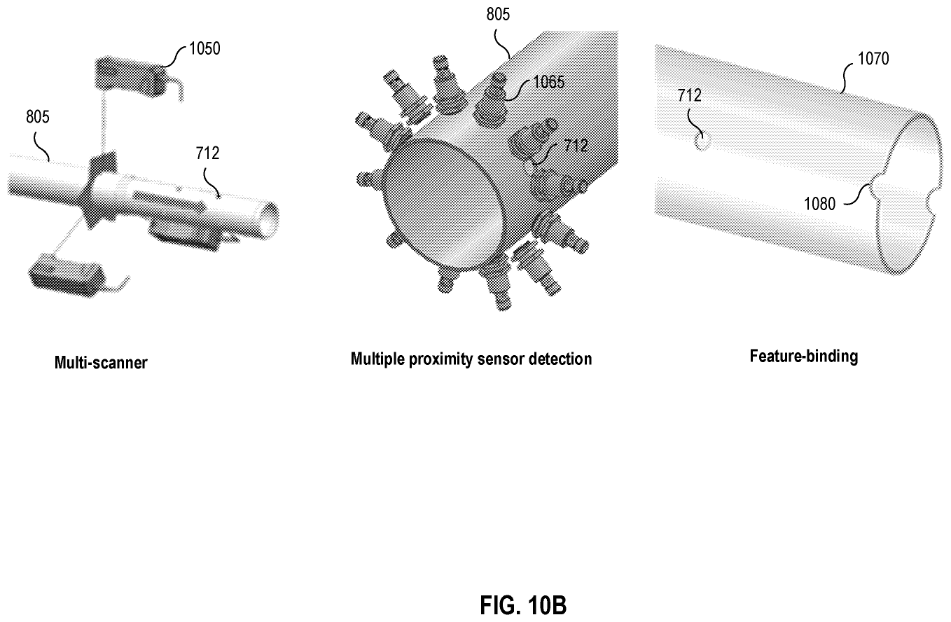

FIG. 10A graphically depicts a process for torque tube orientation alignment in accordance with various embodiments of the invention. After the torque tube is stopped at the first location, the rotator 810 is configured to have the clamp arm 812 in a closed position with the clamp roller 813 firmly pushing the torque tube 805 against the rotation wheel 814 to rotate the torque tube while the profiler 830 performs a scan, as shown in FIG. 10A. In one or more embodiments, the rotator 810 may also apply an axial movement besides an angular rotation for the torque tube such that the torque tube is at a position with determined angular orientation and axial position (e.g., the first bracket hole centered on top and right below the profiler 830).

FIG. 10B graphically depicts alternative approaches for torque tube orientation alignment in accordance with various embodiments of the invention. In a multi-scanner approach, multiple scanners 1050, instead of a single scanner shown in FIG. 10A, may be used to scan the torque tube 805 to quickly locate a bracket hole 712. Since orientation of the multiple scanners is known, a detection of the bracket hole 712 by any one of the multiple scanners would be adequate to determine the radial orientation of the torque tube and, thus, a desired radial alignment to be performed. The multiple scanners may be arranged uniformly around the torque tube, such as in a triad arrangement, as shown in FIG. 10B.

Alternatively, a plurality of proximity sensors 1065, with the orientation of each proximity sensor known, are placed circularly around the torque tube to detect the bracket hole 712 and thus the radial orientation of the torque tube. Similar to the multi-scanner approach, the plurality of proximity sensors may shorten the search time to locate the radial position of the bracket hole for a quicker radial alignment process. Alternatively, an internal light, e.g., a visible LED light, an infrared light, etc., may be placed within the torque tube 805 after its axial position is located and aligned. A plurality of light detection sensor may be placed around the torque tube to detection light through the bracket hole 712 and thus the radial orientation of the torque tube.

Alternatively, a torque tube may incorporate additional features that may be utilized to determine the radial position of the bracket hole. For example, the torque tube 1070 may have an edge groove 1080 that is radially oriented the same direction as the bracket hole 712. Instead of searching the orientation of the bracket hole 712 directly, orientation information of the edge groove 1080 may be used to determine the radial position of the bracket hole 712.

It shall be noted that the abovementioned approaches may be used individually or in combination for faster and more efficient radial positioning and alignment. It is intended that all permutations, enhancements, equivalents, combinations, and improvements thereto that are apparent to those skilled in the art upon a reading of the specification and the drawings are included within the scope of the present disclosure.

### C. Embodiments of Bracket and Module Installation Onto a Torque Tube

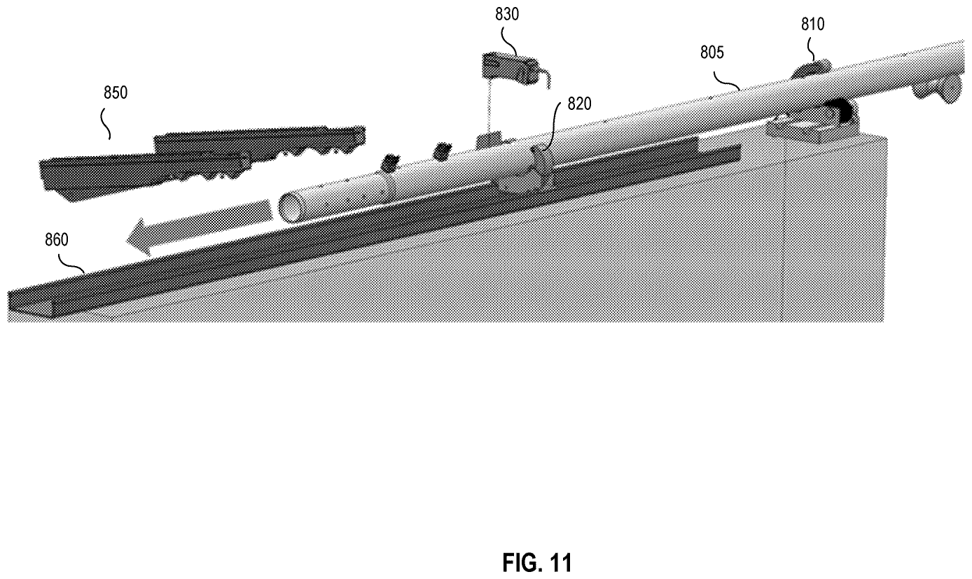

As shown in FIG. 11, after axial position and radial orientation of the torque tube is settled, the rotator 810 opens the clamp arm 812 to release the torque tube. The tube clamp 820 locks the torque tube 805 and slides along the tube advance rail 860 to move the torque tube in a first distance toward the MIB station 850. The first distance is the same as the distance between the MIB station 850 and the profiler 830.

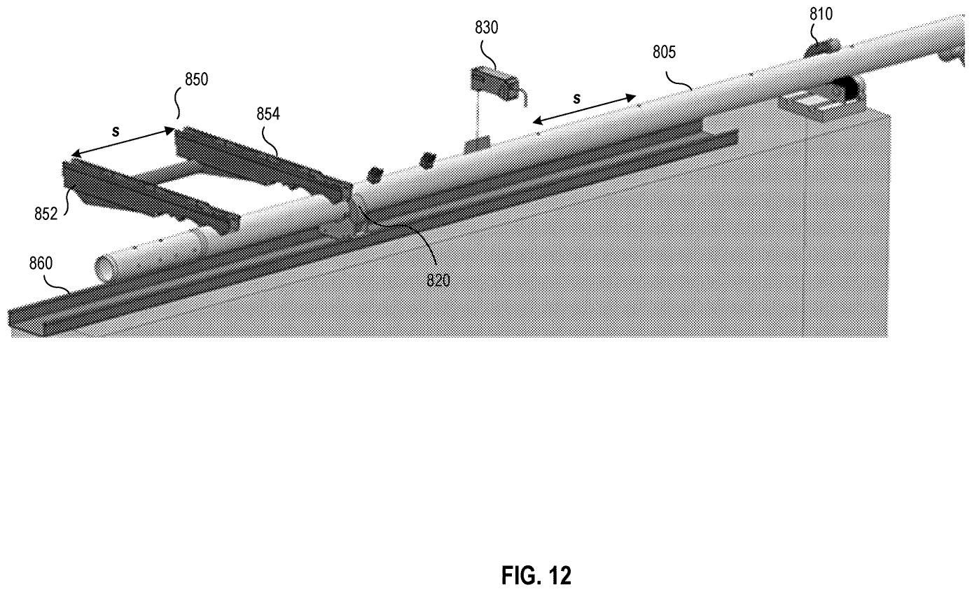

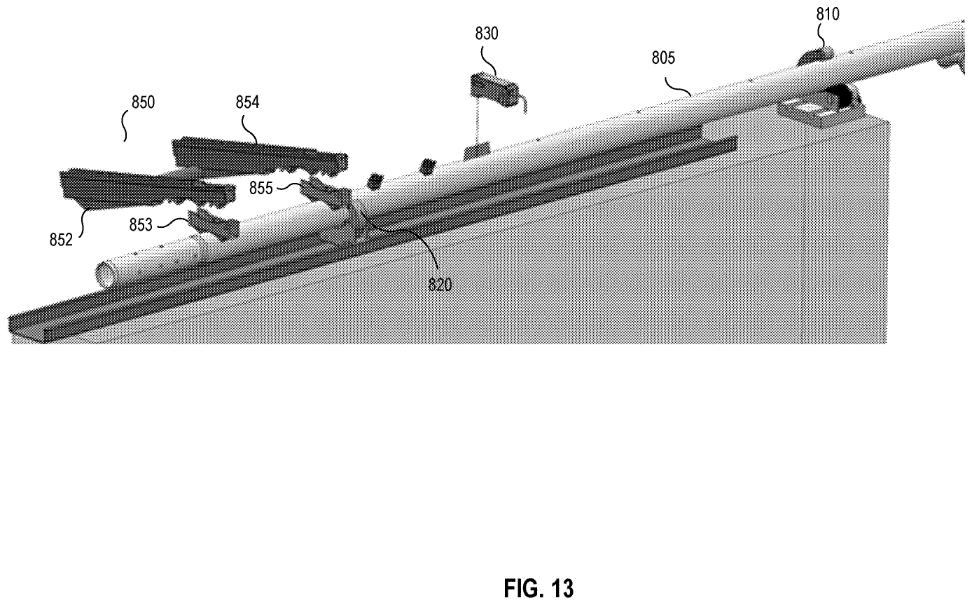

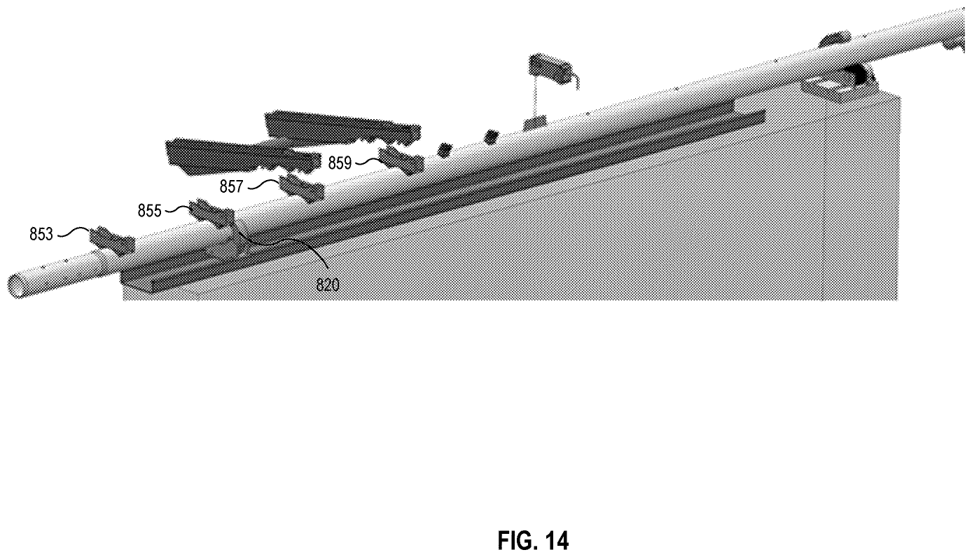

FIGS. 12-14 graphically depict a process for automatic bracket installation onto a torque tube in accordance with various embodiments of the invention. The MIB station 850 may comprise one or more arms to land and attach brackets (e.g., brackets 853/855) to the torque tube. As shown in the exemplary embodiment of FIG. 12, the MIB station 850 comprises a first arm 852 and a second arm 854, which are spaced with the same space s as bracket hole spacing and operate in parallel for higher efficiency for bracket attaching operation. Once landed on the torque tube, the brackets are automatically attached to the torque tube 805 via a bolt, a screw, a rivet, etc. Afterward, the tube clamp 820 slides along the tube advance rail 860 for a second distance (which is the same as the space s) for the MIB station 850 to perform a subsequent attaching operation (e.g., for brackets 857/859). Such a process of torque tube moving and bracket attachment may continue until all bracket holes of the torque tube are filled and automatically resume for a subsequent torque tube.

Depending on the length of the tube advance rail 860, the tube clamp 820 may slide forward from a start position until all bracket attaching operations are completed for the torque tube, and then slide back to the start position again for a subsequent torque tube. Alternatively, the tube clamp 820 may slide forward from a start position for a first bracket-attaching operation (or first few bracket-attaching operations) and then slide backward to the start position for a subsequent bracket-attaching operation, etc.

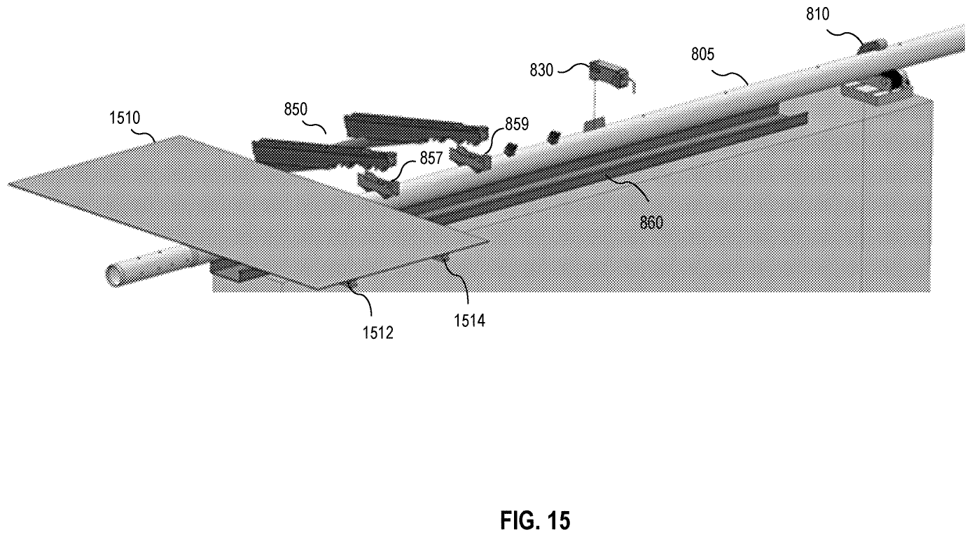

Once the brackets are securely attached to the torque tube, a solar module may be installed onto the attached brackets. In one or more embodiments, installation of a solar module and attachment of brackets may be implemented in parallel, as shown in FIG. 15. When the torque tube 805 has brackets 853/855 installed and proceeds to a position for installation of brackets 857/859, a solar module 1510 may be attached in parallel with module purlins 1512/1514 (or module frames) engaged to the brackets 853/855 (not shown in FIG. 15). Such parallel operations of bracket and solar model installation further increase solar table assembly efficiency.

### D. Embodiments of Automatic Solar Module Feeding

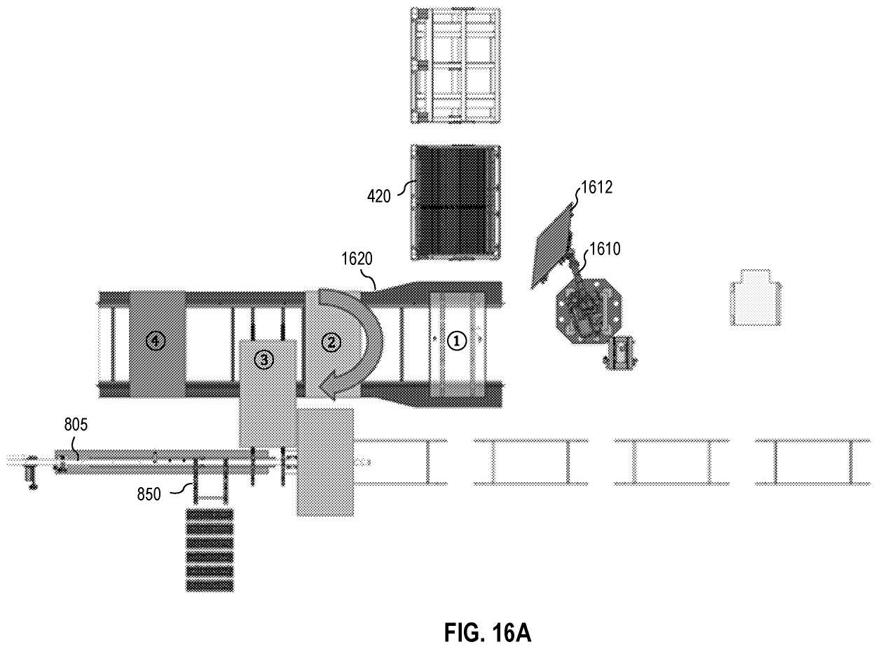

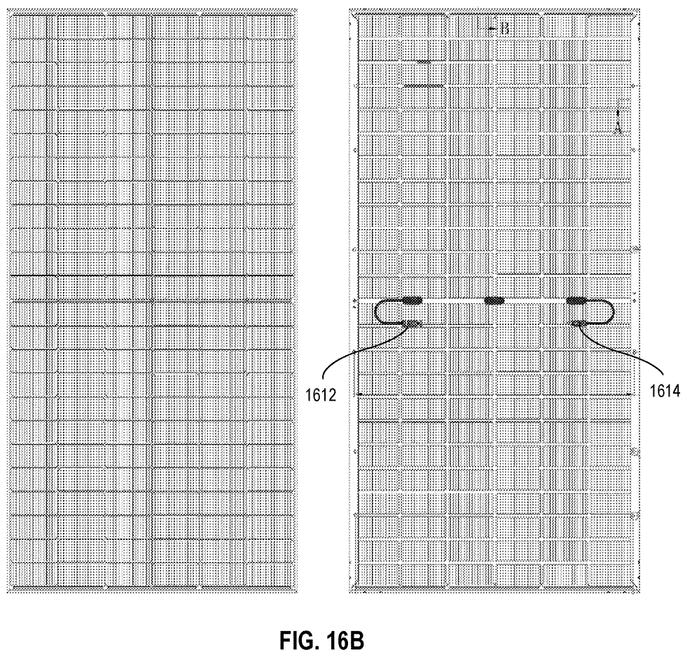

FIG. 16A depicts a top-down view of loading solar modules from the module pallet to the QC/inspection conveyor 1620 and on to the mounting position on the torque tube/module interface rails in accordance with various embodiments of the invention. A robot 1610 fetches a solar module 1612 from a solar module pallet 420 and blindly places the fetched solar module on a module conveyor 1620 where a toothed chain/conveyor interfaces with the frames of the solar module to align and advances the solar module to an inspection station, as shown in step \textcircled{1} in FIG. 16A. The inspection station may be located between \textcircled{1} and \textcircled{2} shown in the figure and configured to perform inspection/QC for solar module(s). The inspection/QC area can be expanded to accommodate multiple inspections or if some inspections take more time than the robot pick time.

Afterward, the position of the solar module is scanned, as shown in step \textcircled{2} in FIG. 16A. If the solar module needs to be rotated (e.g., from a traverse position into a longitudinal or N-S orientation), the solar module is raised and rotated. The rotation is to orient the module to a correct polarity in the N-S direction to match the polarity of the tracker. A solar module may have a positive connector 1612 on one side and a negative connector 1614 on the opposite side, as shown in FIG. 16B. Since the tables are inserted towards a slew drive/motor which is situated in the middle of the row, the modules on tables to one side of the motor need to have their positive connectors pointing towards the swaged end of the tables and away from the swaged end of the tables on the other side of the motor. Different options may be used for solar module scanning. For example, a barcode scan may be used to identify each module and where it needs to be installed on the solar site, through manufacturing execution system (MES) software. Scanning a barcode of a solar module can validate whether the orientation of the module is correct. The barcode may be generally placed on one end of the module. If the solar module is improperly oriented, the barcode will not be in the expected location, and the solar module needs to be rotated correctly. The rotation is mainly done to ensure that the solar modules have the correct polarity with respect to N-S direction. A quality scan may also be used for scanning for module damage, cracked glass, etc.

Solar modules that pass quality control (QC) check are staged for assembling onto MIBs, as shown in step \textcircled{3} in FIG. 16A. The QC check may be a visual check, using a camera and automatic image recognition/analysis algorithm, for possible damaged or distorted cell, cracked or chipped front/backside glass, damaged back sheet or frame, etc. Solar Modules that do not pass QC check are advanced to a different position for off-loading from the assembling process, as shown in step \textcircled{4} in FIG. 16A.

### E. Embodiments of Automatic Solar Table Assembly

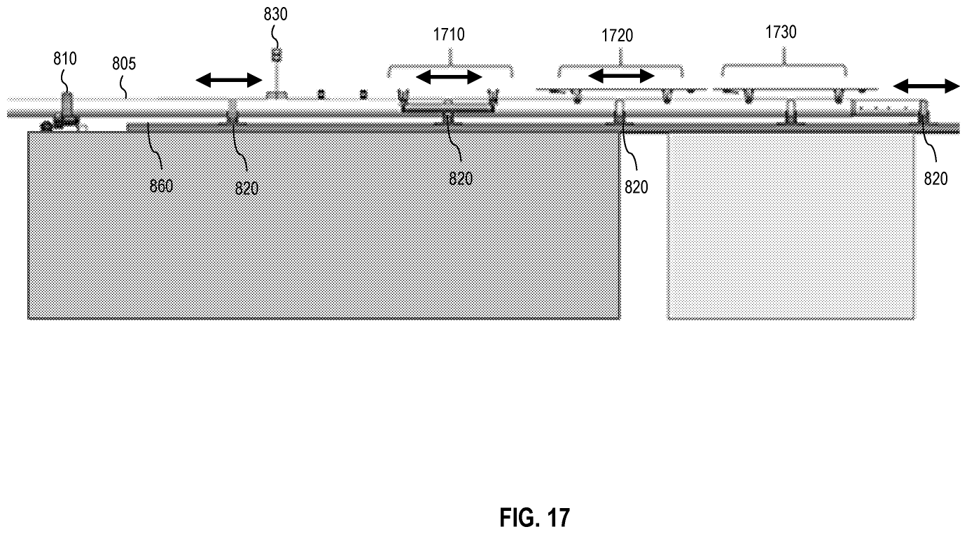

FIG. 17 depicts a side view of automatic solar table assembly process in accordance with various embodiments of the invention. As shown in FIG. 17, multiple tube clamps 820 may be used for a more balanced support of the torque tube 805. The tube clamps may or may not work in synchronization. When the torque tube 805 needs to advance, the rotator 810 releases the torque tube, and one or more tube clamps 820 lock the torque tube and slide synchronically along the tube advance rail 860 to move the torque tube forward. The tube clamps 820 may slide forward with a forward range (e.g., 1240 mm) and backward with a backward range (e.g., 199 mm). It shall be noted that the tube clamps 820 may be grouped into a first set of tube clamps and a second set of tube clamps to perform different operations, e.g., engaging at different times or even engaging different tubes. For example, the first set of rail clamps grabs a torque tube and advances it while the second set of rail clamps is not engaged. The first set of rail clamps moves a prescribed distance to a next location where the second set of rail clamps engages and the first set of rail clamps releases and slides back along the tube advance rail 860 to the original position. The second set of rail clamps holds the torque tube in place until the first set of tube clamps slides back and takes over, Afterwards, the second set of rail clamps releases and returns to their original position.

Automatic solar table assembly comprises multiple stages, e.g., a torque tube positioning stage as described in Section B, a bracket installation stage (also referred to as a MIB stage) 1710, a module attachment stage 1720, and a lock stage 1730 to securely lock the attached solar module. Finished solar table is advanced with enough clearance (e.g., at least double the forward range of the rail clamps) to prevent interference with operations of subsequent torque tubes. In one or more embodiments, the lock stage 1730 may be a wedge stage to automatically and securely lock the attached solar module using one or more wedges. The module attachment stage 1720 and the lock stage 1730 may be at the same station (location) dependent on layout and cycle time of each of the stages. In one or more embodiments, the solar modules may be framed modules for a solar table, a module support bracket is installed on a last solar module near a swaged end of the torque tube, and the lock stage 1730 may be a stage for rivet/bolt&nut installation instead of a wedge stage.

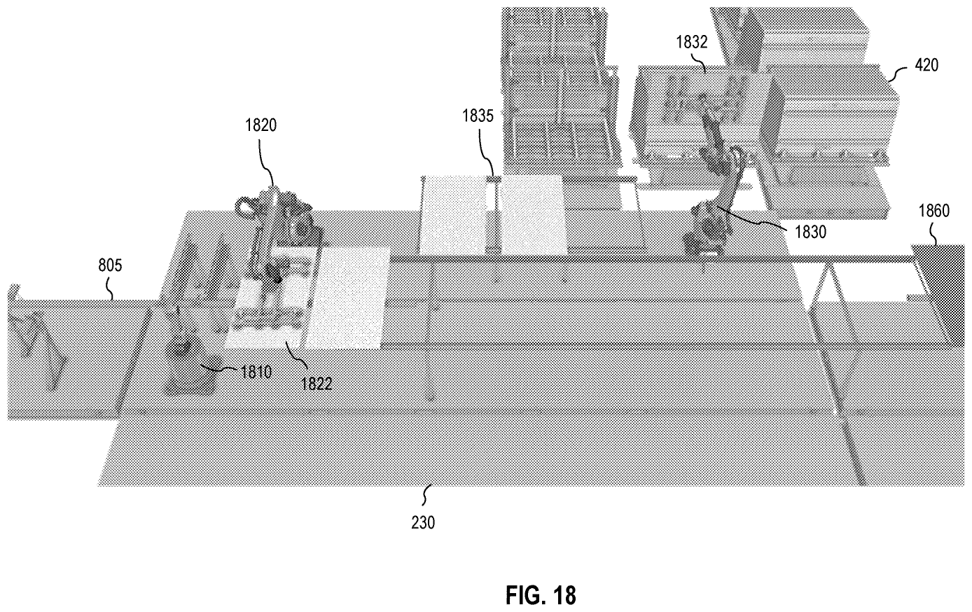

FIG. 18 graphically depicts a process for automatic solar table assembly in accordance with various embodiments of the invention. The automatic solar table assembly may be performed in the table assembly station 230 with the involvement of multiple robots. A torque tube 805 fed from the torque tube dispenser 220 is handled, after tube orientation positioning, by a first robot 1810 for attaching MIBs. Afterward, a second robot 1820 installs a solar module 1822 on the attached MIBs. Assembled solar tables 1860 are dispatched from the table assembly station for storage or transportation. A third robot 1830 fetches a solar module 1832 from a solar module pallet 420 and lays down the fetched solar module onto a module conveyor 1835 for the second robot 1820 to pick up.

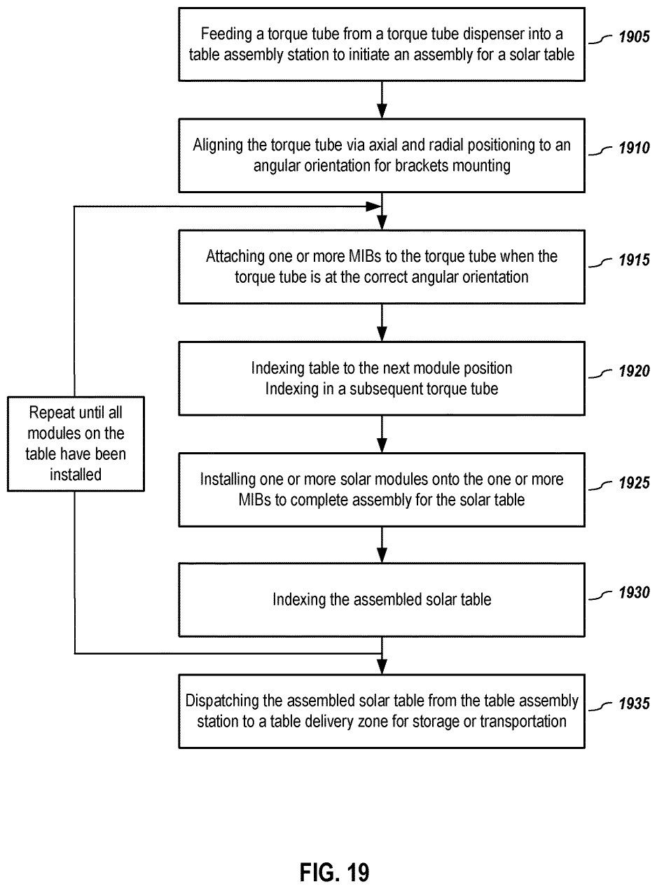

FIG. 19 depicts a process for automatic solar table assembly in accordance with various embodiments of the invention. In step 1905, a torque tube is fed from a torque tube dispenser into a table assembly station to initiate an assembly for a solar table. In step 1910, the torque tube is aligned via axial and radial positioning to an angular orientation for brackets mounting. In step 1915, one or more MIBs are attached to the torque tube when the torque tube is at the angular orientation. In step 1920, a subsequent torque tube is indexed in such that a subsequent tube alignment may be implemented while the torque tube attached with MIBs is indexed out for solar module installation.

In step 1925, one or more solar modules are installed onto the one or more MIBs to complete assembly for the solar table. The one or more solar modules may be fetched from modules placed on a module conveyor and installed onto the MIBs. The modules on the module conveyor are fetched by a robot from a module pallet, laid on the module conveyor, oriented in a north-south (N-S) direction, and passed a QC check for installation on the one or more MIBs. In one or more embodiments, MIB attaching and module installation may be implemented in parallel for improved efficiency. In one or more embodiments, in cases framed modules being used for a solar table, a module support bracket is installed on a last solar module near a swaged end of the torque tube. In one or more embodiments, A BHA is also installed to support the table near an un-swaged end of the torque tube.

The steps of 1920 and 1925 may be implemented in parallel for higher assembly efficiency. In step 1930, the assembled solar table is indexed for assembling records. Steps 1915 to 1930 are repeated for each of the remaining modules on the table until all solar modules are installed. In step 1935, the assembled solar table is dispatched from the table assembly station to a table delivery zone for storage or transportation.

### F. Embodiments of Assembled Solar Table Storage for Delivery

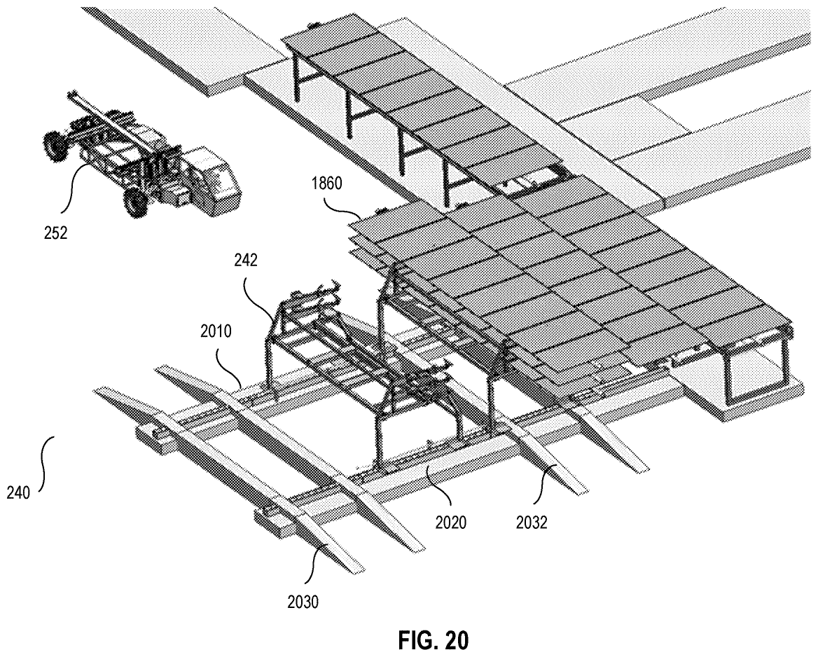

FIG. 20 depicts a perspective view of loading assembled solar tables onto table racks in accordance with various embodiments of the invention. Assembled solar tables are dispatched automatically from the table assembly station to the table delivery zone 240, where the solar tables 1860 may be stacked onto a solar table rack 242 or delivered directly to a transport/landing vehicle 252.

In one or more embodiments, the solar table rack 242 is able to hold multiple assembled solar tables and is slidable along a pair of rack rails 2010/2020. Once the solar table rack 242 is fully loaded with assembled solar tables, the solar table rack 242 may slide toward an unloading area 2030 where the motorized vehicle 252 may park underneath to off-load a solar table or even take the entire solar table rack 242 for delivery. The unloading area 2030 may also be the place where a transport vehicle 252 drops an empty solar table rack onto the rails for solar table re-loading. As shown in FIG. 20, multiple unloading areas (e.g., 2030/2032) may be placed along the rack rails to allow parallel solar table rack dropping and/or unloading operations.

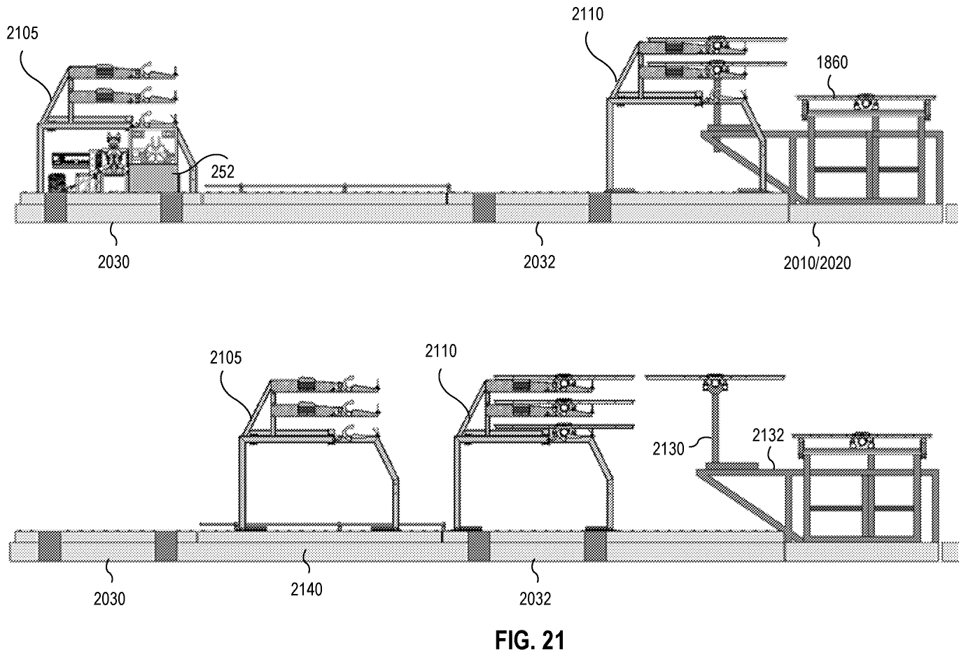

FIG. 21 depicts a front view of loading an assembled solar table onto a mobile vehicle for delivery in accordance with various embodiments of the invention. An assembled solar table 1860 is dispatched from the table assembly station and picked up by a loader 2130 that is slidable on a loader frame 2132. The loader 2130 stacks the solar table 1860 onto a solar table rack 2110. The loader 2130 may be height-adjustable for solar table loading into rack slots of different heights.

Once fully stacked, the solar table rack 2110 slides along the rack rails 2010/2020 to an unloading area 2032 for rack picking up by a motorized vehicle. In the meantime, an empty solar table rack 2105 may be dropped by a motorized vehicle 252 to another unloading area 2030. The solar table rack 2105 slides along the rack rails 2010/2020 to a staging area 2140, waiting for solar table re-loading.

Such a configuration of rack loading with multiple unloading areas for table delivery zone allows a high-capacity buffer zone for table rack loading and uninterrupted solar table assembly. Furthermore, the multiple unloading areas accommodate parallel solar table rack dropping and loading, thus further improving solar table delivery efficiency.

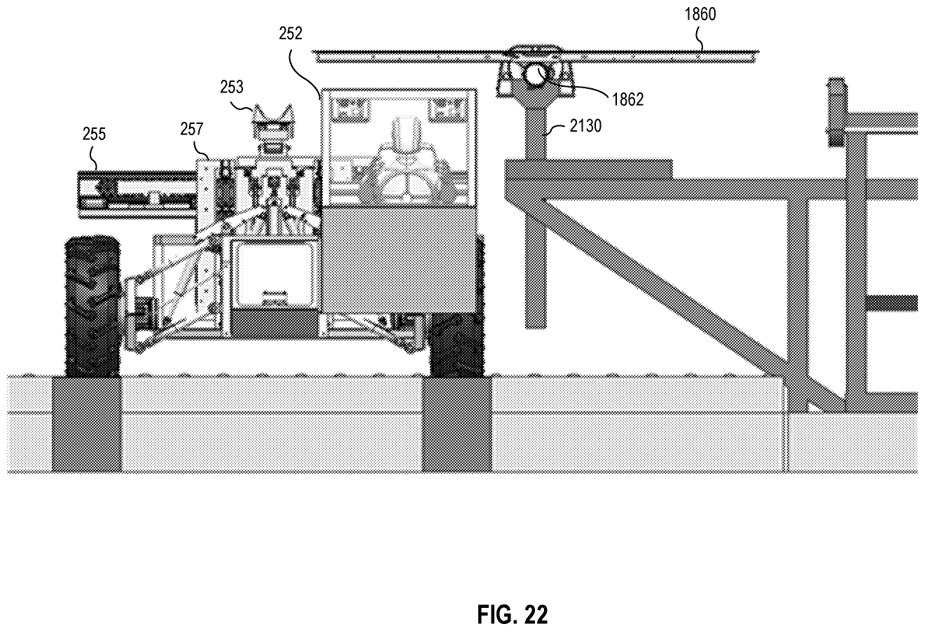

In one or more embodiments, due to various restrictions such as factory size, a table delivery zone may have a compact layout without rack loading. Instead, assembled solar tables are directly loaded onto a transport vehicle for delivery. FIG. 22 depicts a side view of loading an assembled solar table onto a mobile vehicle for delivery in accordance with various embodiments of the invention. Such a setup may be great for sites where distance to a central factory is short and high density transportation is not needed from solar table racks.

As shown in FIG. 22, the loader 2130 may load an assembled solar table 1860 directly onto a holder 253 of a transport vehicle 252. The holder 253 may be moved horizontally by a side-shift element 255 and vertically by a height-shift element 257 for position alignment to receive the solar table 1860 from the loader 2130. Afterward, the motorized vehicle 252 transports the solar table 1860 for on-site installation and comes back for re-loading. The handoff process may be automated, manual, or a combination of the two. The loading process may be a combination of movements of the loader and the height/side-shift elements on the transport vehicle. For example, the solar table 1860 may be presented above the transport vehicle 252. Then the transport vehicle 252 moves vertical and horizontal actuators to hold the torque tube 1862 of the solar table 1860. Afterwards, the loader 2130 releases the solar table 1860 and moves out of the way.

### G. Embodiments of Assembled Solar Table Rolling Off-Line

Once the assembling of a solar table is completed, the solar table needs to be rolled off the assembly line quickly and safely to empty assembly space for subsequent solar tables. Described hereinafter are embodiments of rolling assembled solar table off the assembly line for improved overall assembly efficiency. The described embodiments enable table pick up from the factory output and offload of the table at any time without constraints on where the mobile transport or the factory cycle was at. The described embodiments also allow assembled solar table to be positioned in a drop off position without consideration of where a mobile transport is, therefore avoiding the situation wherein the assembly line needs to wait for solar table pick up vehicle to return before an assembled solar table could be moved into the pickup position. Accordingly, backup in the factory due to slow table pickup and offloading may be effectively prevented.

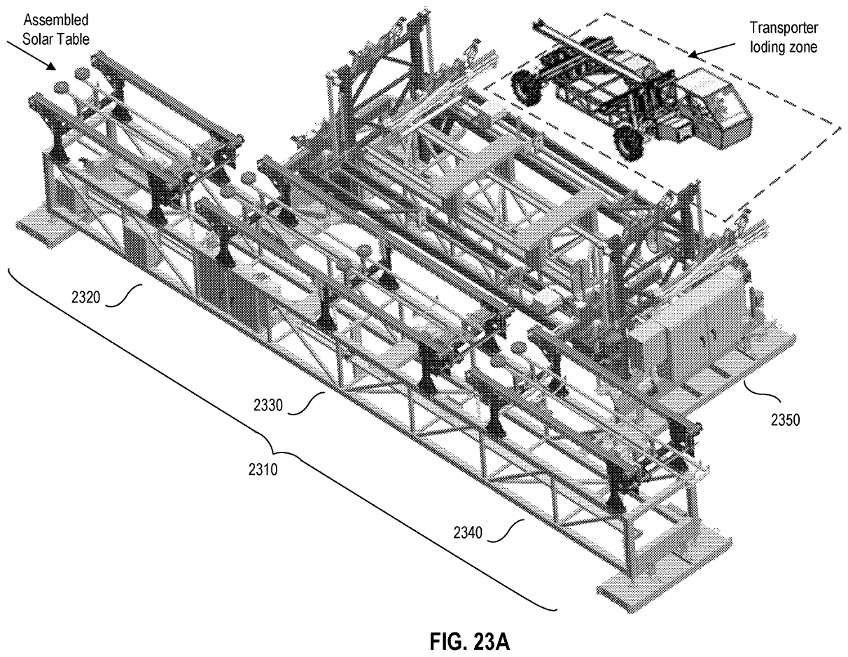

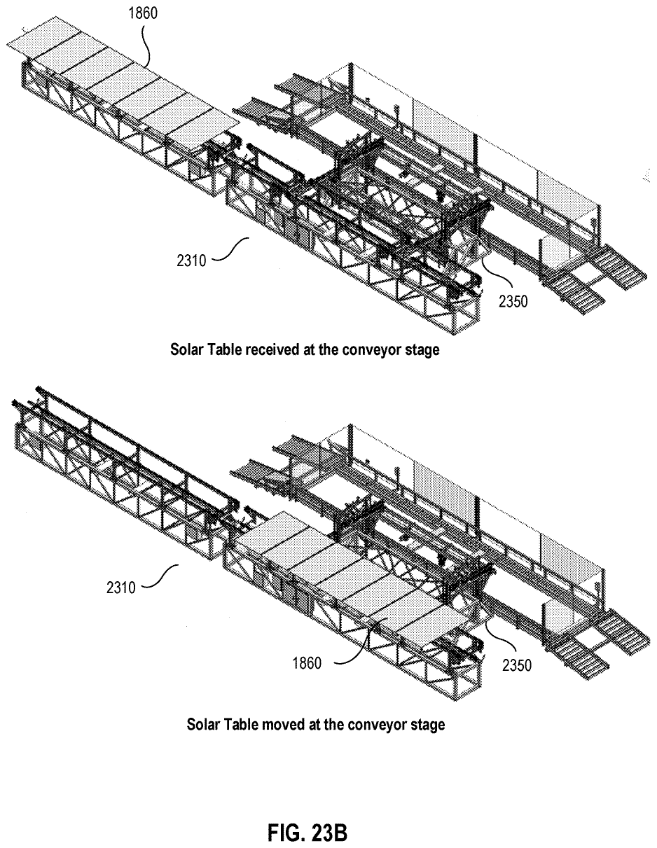

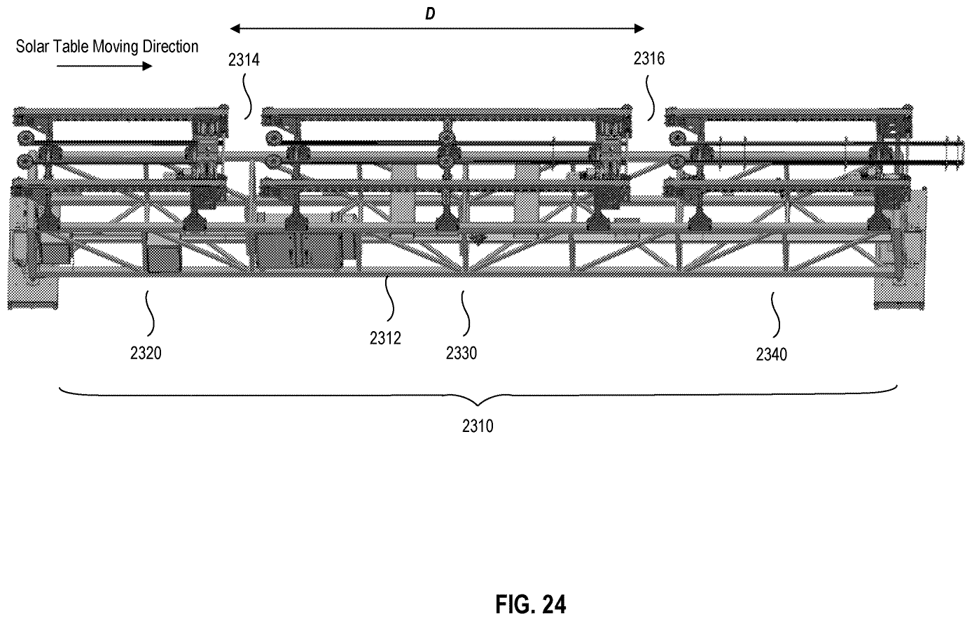

FIG. 23A depicts a perspective view of a system for offloading assembled solar tables in accordance with various embodiments of the invention. The system comprises a conveyor stage 2310 placed downstream of an assembling line (e.g., the assembly station shown in FIG. 18) to receive assembled solar tables and a table transfer stage 2350 placed in proximity to the conveyor stage 2310 for table transferring from the conveyor stage 2310 to mobile transports. FIG. 23B depicts a perspective view of a solar table received and moved in a conveyor stage in accordance with various embodiments of the invention. A solar table 1860 assembled in the assembly line is received at the conveyor stage 2310 and moved to a position ready to be transferred to the table transfer stage 2350.

The conveyor stage 2310 may comprise one or more conveyor sections, e.g., a first conveyor section 2320, a second conveyor section 2330, and a third conveyor section 2340 as shown in FIGS. 23A & 24. The conveyor sections, all supported by a conveyor base frame 2312, may operate independently or collectively. There are section gaps 2314/2316 between the second conveyor section 2330 and the first/third conveyor sections such that an assembled solar table may be lifted up through the section gaps and transferred to the table transfer stage 2350. The section gaps 2314 and 2316 have an inter-gap distance D. Specifically, the table transfer stage 2350 is placed in parallel to the conveyor stage 2310 and next to the second conveyor section 2330 to enable solar table pickup through the section gaps.

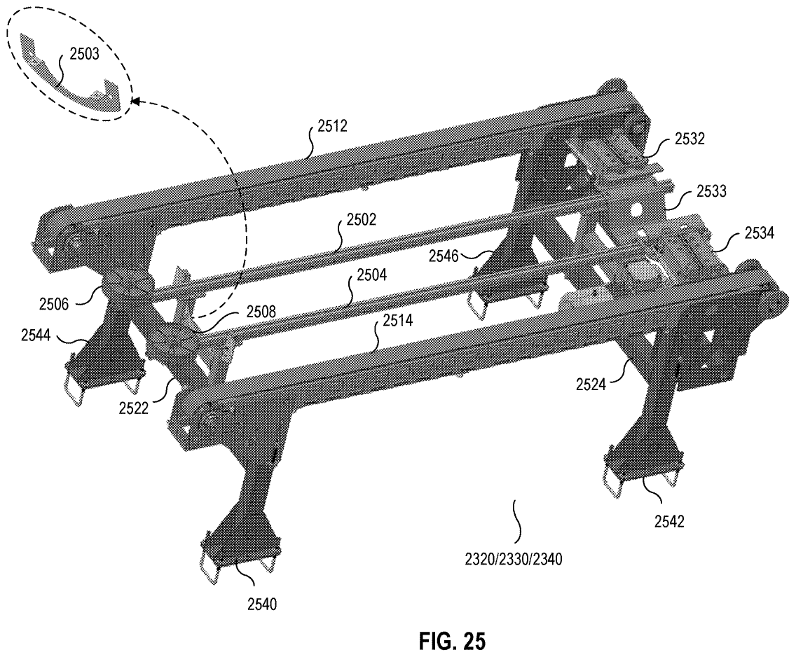

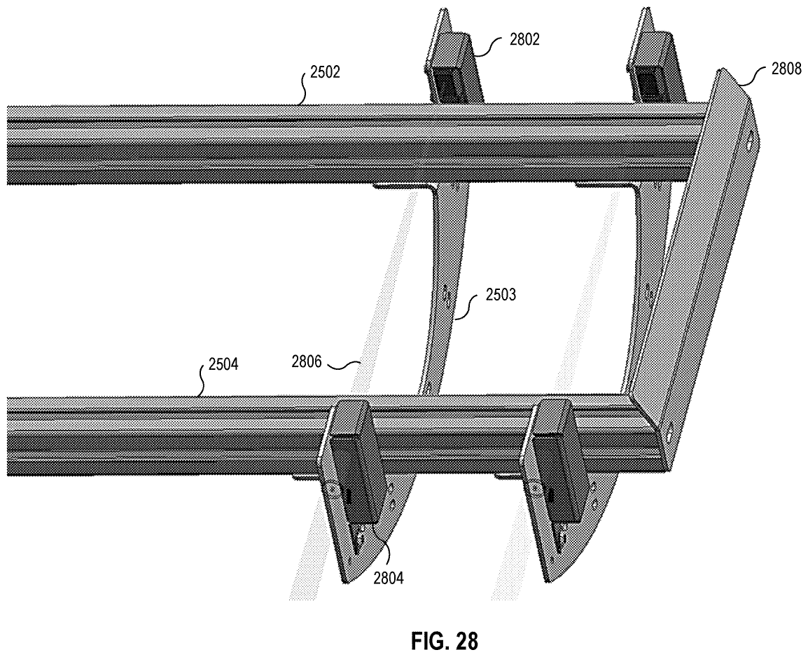

The conveyor sections may have similar structures, e.g., frame couplers, drive components, tube holder component, etc. FIG. 25 depicts a perspective view of a conveyor section in accordance with various embodiments of the invention. Structures shown in this figure may be applicable to the first, second, or third conveyor sections 2320/2330/2340. The conveyor section comprises a plurality of conveyor couplers 2540/2542/2544/2546 for securely coupling the conveyor section to the conveyor base frame 2312, a pair of belt conveyors 2512/2514 longitudinally coupled between the conveyor couplers for solar table support and movement, a pair of coupling frames 2522/2524 traversely coupled between the conveyor couplers, a pair of MIB guide rails 2502/2504 coupled to the pair of coupling frames 2522/2524 to guide torque tube movement, and a pair of lock actuators 2532/2534 coupled respectively to the pair of MIB guide rails 2502/2504 for active torque tube locking or unlocking. The pair of belt conveyors may be electrically powered together for balanced movement of solar tables. In one or more embodiments, a pair of guide wheels 2506/2508 may be placed on a leading end of the MIB guide rails 2502/2504, respectively. The guide wheels 2506/2508 guide the torque tube and keep it aligned along the centerline of the conveyor. In other words, the guide wheels 2506/2508 interact with the module brackets should the solar table gets misaligned as it travels down the conveyor and nudges the table back in alignment. Furthermore, one or more brackets 2503 may be placed between the pair of MIB guide rails 2502/2504 for mounting laser proximity sensors 2802/2804 (as shown in FIG. 28 for example) that detects the presence of the table/torque tube at the different positions along the conveyor.

In one or more embodiments, an actuator connector 2533 is placed between the pair of lock actuators 2532/2534. The actuator connector 2533 is a fastened between the pair of MIB guide rails 2502/2504 and functions as an anchor plate to attach the lock actuators 2532/2534. The MIB guide rails 2502/2504 establish the space where the MIBs can travel, and thus guide and align the solar table as it is travelling down the conveyor. In this configuration, the actuator connector 2533 not only functions to provide a robust mechanical connection for the actuators but also provides an additional torque tube support right at the position of the actuators.

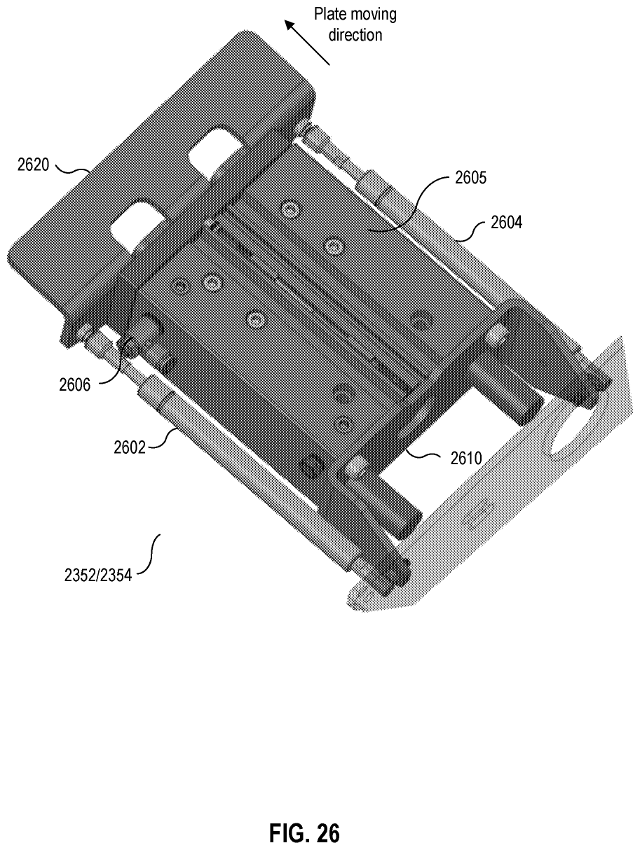

FIG. 26 depicts a detailed view of a lock actuator 2532/2534 in a conveyor section in accordance with various embodiments of the invention. The lock actuator, attached to the actuator connector 2533 (not shown in FIG. 26), comprises an actuator body 2605, a fixed end plate 2610, a moveable end plate 2620, a pair of struts 2602/2604 coupled between the first end plate 2610 and the second end plate 2620. The lock actuator may be pneumatically, hydraulically, or electrically operated to push or retract the moveable end plate 2620. As shown in exemplary embodiment of FIG. 26, the lock actuator is pneumatically controlled via an air intake 2606.

Referring to FIG. 25, the lock actuators 2532/2534 may be configured to operate synchronically. Once the lock actuators are activated, the moveable end plates of both lock actuators are pushed to hold a torque tube (not shown in FIG. 25) of a solar table in position, thus keeping the solar table secure.

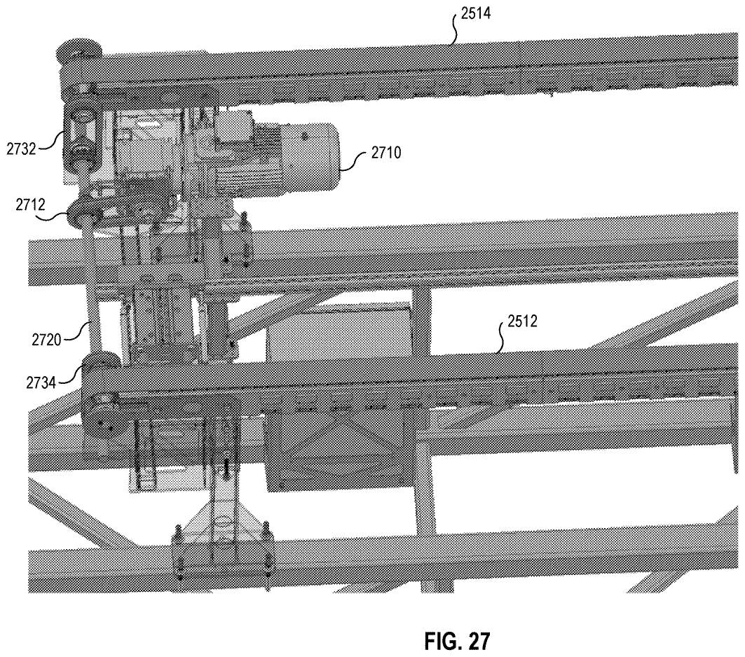

FIG. 27 depicts a perspective view of drive components of a conveyor section in accordance with various embodiments of the invention. For clarity purpose, some components are not shown or rendered transparent in FIG. 27. The pair of belt conveyors 2512/2514 may both be powered by a conveyor motor 2710, which drives a drive shaft 2720 via a drive gear 2712. The drive shaft 2720 couples to the pair of belt conveyors 2512/2514 through coupling gears 2732/2734 respectively. The conveyor motor 2710 may be operated in collaboration with the lock actuators 2532/2534. For example, when the lock actuators 2532/2534 are activated to lock a torque tube of an assembled solar table, the conveyor motor 2710 may automatically stops. When the conveyor motor 2710 starts, the lock actuators 2532/2534 are automatically disactivated to unlock the torque tube to avoid any conflict between operations of the electric motor and the lock actuators.

In one or more embodiments, stopping mechanism may be adopted in a last conveyor stage to prevent a solar table from accidentally rolling out of a conveyor stage. FIG. 28 depicts a perspective view of proximity sensor arrangement in accordance with various embodiments of the invention. A safety sensor, comprising an emitter 2802 and a receiver 2804, is placed near a downstream edge of the last conveyor section (e.g., the third conveyor section 2340 shown in FIG. 23A). The emitter 2802 and the receiver 2804 are both attached to a bracket 2503 and aligned in position for obstruction detection. The emitter 2802 transmits a signal 2806, normally an infrared beam, to be received by the receiver 2804. If a solar table is rolling toward the edge of the third conveyor section 2340 and the torque tube of the solar table blocks the infrared beam 2806, the receiver 2804 sends a trigger signal to the conveyor motor 2710 and/or the lock actuators 2532/2534 to stop the belt conveyors and/or activate the lock actuators 2532/2534, thus preventing the solar table from moving out of third conveyor section 2340 and also ensuring that the end of the solar table is in a correct position to avoid interference between the MIBs and handling grabbers on the table transfer stage and the transporter vehicle.

In one or more embodiments, a stop plate 2808 may be installed at the edge across the pair of MIB guide rails 2505/2504 as an additional or a last measure to prevent the solar table from being rolled out, in case of a malfunctioning of the receiver 2804 or a communication glitch between the receiver 2804 and the conveyor motor/the lock actuators.

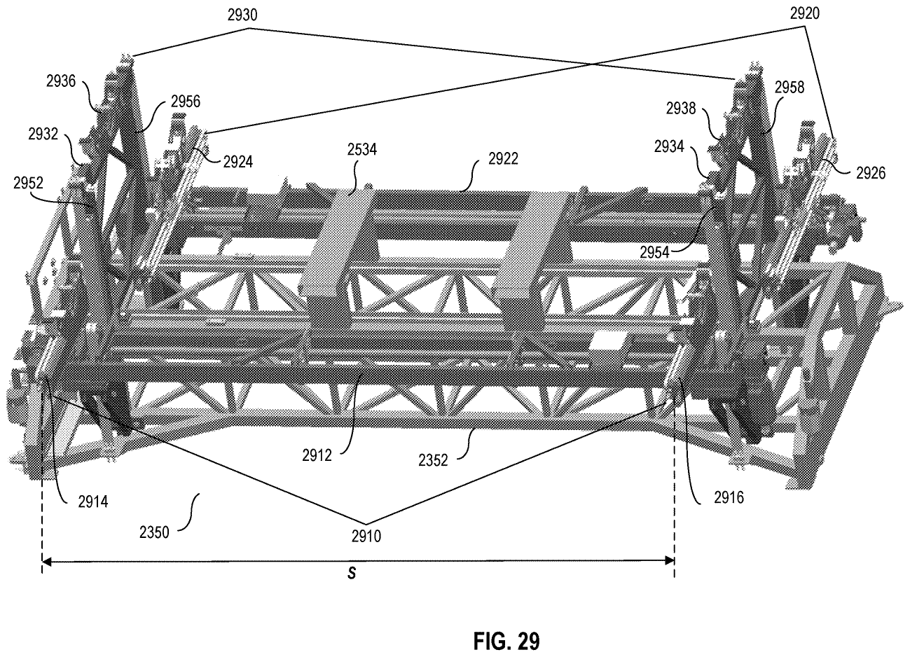

FIG. 29 depicts a perspective view of a table transfer stage comprising multiple table transfer sections in accordance with various embodiments of the invention. The table transfer stage 2350 comprises a first table transfer section 2910 facing the conveyor stage, a second table transfer section 2920, and a third table transfer section 2930 in between the first table transfer section 2910 and the second table transfer section 2920. The table transfer sections, all supported by a table transfer stage base frame 2352, may operate independently or in collaboration for smooth table transfer operation. In one or more embodiments, the table transfer stage base frame 2352 incorporates a pair of forklift pockets 2354, which may be used to lift the table transfer stage 2350 for location/position adjustment. The table transfer stage 2350 is aligned in parallel to the conveyor stage 2310 and positioned next to the second conveyor section 2330, as shown in FIG. 23A.

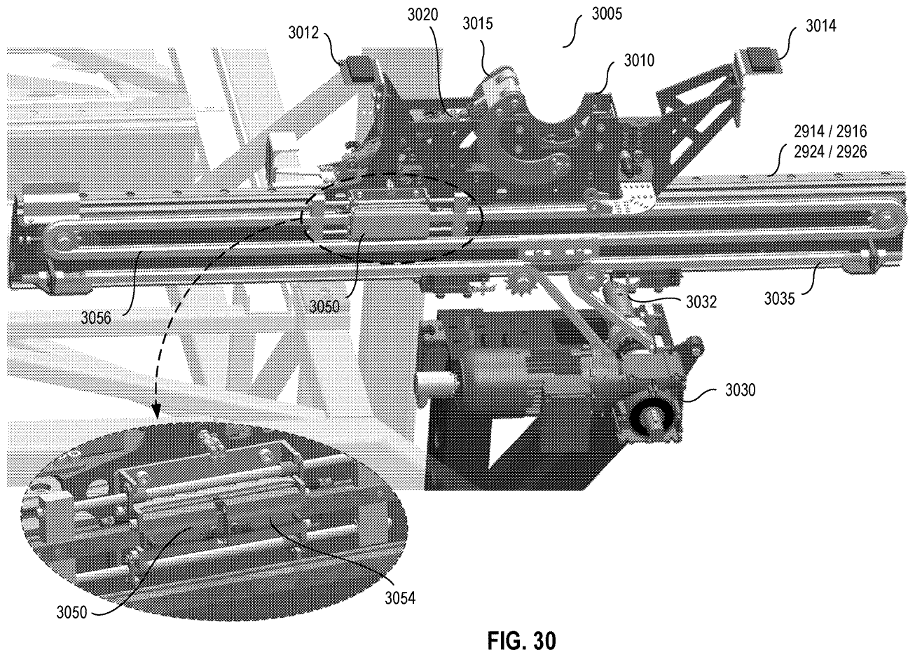

The first table transfer section 2910 comprises a first transfer section frame 2912, a first pair of table transfer rails 2914/2916 attached to the first transfer section frame 2912. The first pair of table transfer rails 2914/2916 has an inter-rail space S same as the inter-gap distance D shown in FIG. 23A. The first pair of table transfer rails 2914/2916 extend to the section gaps 2314/2316 respectively, such that torque tube holders (details shown in FIG. 30) attached on the table transfer rails may slide underneath the section gaps 2314/2316 to grab and hold a torque tube of the solar table to be transferred.

Similarly, the second table transfer section 2920 comprises a second transfer section frame 2922, a second pair of table transfer rails 2924/2926 attached to the second transfer section frame 2912. The first transfer section frame 2912 is slidably attached to vertical support frames 2952/2954 in a vertical direction for height adjustment. Similarly, the second transfer section frame 2922 is slidably attached to vertical support frames 2956/2958 in a vertical direction for height adjustment. The first table transfer section 2910 and the second table transfer section 2920 are offset to avoid any operation interference during solar table transferring from the first transfer section toward the second table transfer section.

The third table transfer section 2930, also referred to as an intermediate table transfer section, is configured as a transition section between the first table transfer section 2910 and the second table transfer section 2920. A solar table fetched from the conveyor stage 2310 is transferred from the first table transfer section 2910 to the third table transfer section 2930. Afterwards, the solar table is then transferred to the second table transfer section 2920. The third table transfer section 2930 comprises a pair of support bars 2932/2934 and a third pair of torque tube holders 2936/2938 attached to the support bars respectively. The pair of support bars 2932/2934 are supported by the vertical support frames 2952/2954/2956/2958, thus positioned above the table transfer stage base frame 2352; therefore, the first transfer section frame 2912 and the second transfer section frame 2922 need to slide upward to reach the pair of support bars 2932/2934 for solar table transfer operations. Furthermore, the torque tube holders 2936/2938 may be fixed on the support bars 2932/2934 respectively for simplicity of the overall system structures. The configuration of the third table transfer section 2930 as a transition section enables multiple options of parallel table transfer operations. For example, table fetching from the conveyor stage 2310 to the first table transfer section 2910 may be performed in parallel to table transferring from the third table transfer section 2930 to the second table transfer section 2920. In another example, table transfer from the first table transfer section 2910 to the third table transfer section 2930 may be performed in parallel to table transferring from the second table transfer section 2920 to a mobile transport (not shown in FIG. 29). Such parallel table transfer capability enables great flexibility and provides improved efficiency for solar table transfer operations.

In one or more embodiments, a solar table may be transferred from the first table transfer section 2910 to the second table transfer section 2920 directly, without needing the involvement of the third table transfer section 2930. For example, the first table transfer section 2910 may fetch a solar table from the conveyor stage 2310 and then slide upward and toward the second table transfer section 2920, which may slide to an offset position to receive the solar table from undeath. Such direct table transfer embodiment may require less components for table transfer operation, and may still support some parallel table transfer operations, although less parallel operation options compared to the embodiment of three table transfer sections. For example, with the two table transfer sections, table fetching from the conveyor stage 2310 to the first table transfer section 2910 may still be performed in parallel to table transferring from the second table transfer section 2920 to a mobile transport.

A torque tube holder is slidably attached to each table transfer rail 2914/2916/2924/2926. FIG. 30 depicts a detailed view of a torque tube holder on a table transfer rail for horizontal movement in accordance with various embodiments of the invention. Each torque tube holder 3005 is slidably attached to a corresponding table transfer rail and coupled to a corresponding horizontal rail motor 3030 for sliding control along the table transfer rail. The horizontal rail motor 3030 enables horizontal sliding movement of the torque tube holder 3005 via a drive shaft 3032 and a drive belt/chain 3035.

The torque tube holder 3005 comprises a holder base 3010, a tube clamp 3015 pivotably coupled to the holder base 3010, and a clamp actuator 3020 coupled to the holder clamp 3015 to pivot the tube clamp for torque tube lock or release. The holder base 3010 may have a profile, e.g., a curved or bent indentation, at least partially matching a torque tube for a stable support. In one or more embodiments, the holder base 3010 may have a geometry that will provide a normal force between the torque tube and the holder base 3010 that is sufficiently magnified to enable a holding force high enough to keep the table from rotating. The torque tube holder 3005 may further comprise two anti-rotation wings 3012/3014 placed on opposite side of the holder base 3010 for supporting solar modules or purlins, thus preventing a supported solar table from rotation. The clamp actuator 3020 may be pneumatically, hydraulically, or electrically controlled for extending or retracting, thus closing or opening the tube clamp 3015.

In one or more embodiments, the torque tube holder 3005 may be coupled to a misalignment compensator 3050 that allows some positional flexibility for the torque tube holder 3005 to pick up or drop off the solar table. As shown in the enlarged view (with an exterior cover removed for clear internal structure view), the misalignment compensator 3050 comprises two pneumatic cylinders 3052/3054 linking a drive chain 3056 and the torque tube holder 3005. When the misalignment compensator 3050 is activated (e.g., pressurized), the torque tube holder 3005 is centered and locked in position. When the misalignment compensator 3050 is de-pressurized, the torque tube holder 3005 may slide back and forth, thus allowing some static alignment to compensate for mobile transport misalignment when dropping off the solar table or for solar table misalignment during table pickup from the conveyor belt.

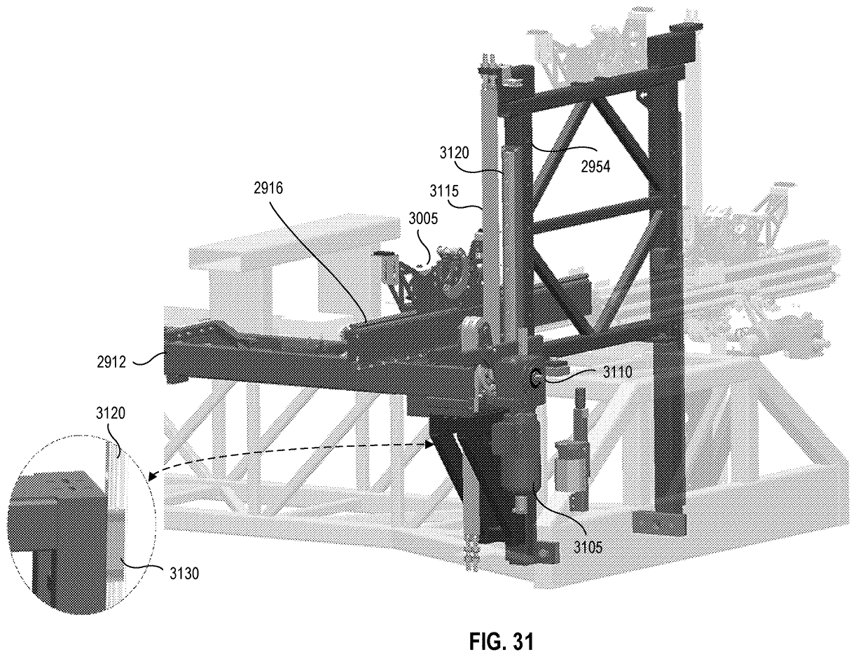

FIG. 31 depicts a detailed view of a torque tube holder on a sliding rail supported on a frame capable of vertical movement in accordance with various embodiments of the invention. It shall be noted that the structural configuration shown in the figure is applicable to both ends of the first transfer section frame 2912 and the second transfer section frame 2922. The table transfer rail 2916 is attached to one end of the first transfer section frame 2912, which is slidably coupled, at both frame ends, to two vertical rails via corresponding vertical rail couplers (with only the vertical rail 3120 and the vertical rail coupler 3130 shown in FIG. 31).

The vertical rail 3120 may be installed on the vertical support frame 2954 or be part of the vertical support frame 2954. A vertical rail motor 3105 controls vertical movement of the first transfer section frame 2912 via a drive shaft 3110 and a coupling belt/chain 3115. It shall be noted that the vertical rail motor 3105 and another vertical rail motor coupled to the opposite end of the first transfer section frame 2912 may operate in collaboration for balanced and smooth vertical motion control.

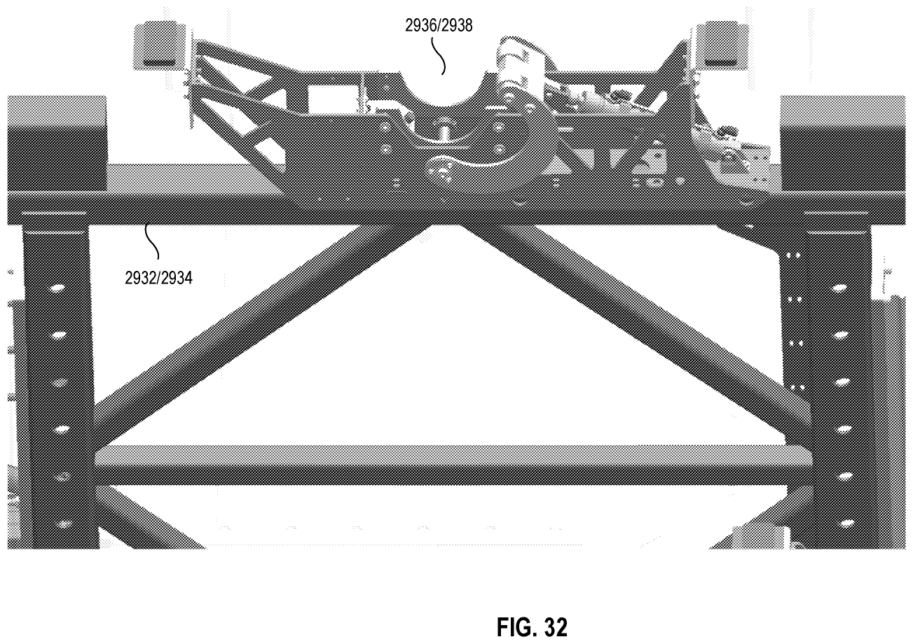

FIG. 32 depicts a detailed view of a torque tube holder in a third table transfer section in accordance with various embodiments of the invention. The torque tube holders 2936/2938 are attached to the support bars 2932/2934 respectively, and have similar structure components, e.g., a holder base, a tube clamp, a clamp, two anti-rotation wings, etc., to the torque tube holder 3005 described in FIG. 30. Different from the torque tube holders attached on sliding rails, the torque tube holders 2936/2938 may be fixed on the support bars 2932/2934 respectively for simplicity of the overall system structures, since the torque tube holders attached on sliding rails may be operated to slide underneath for solar table transfer.

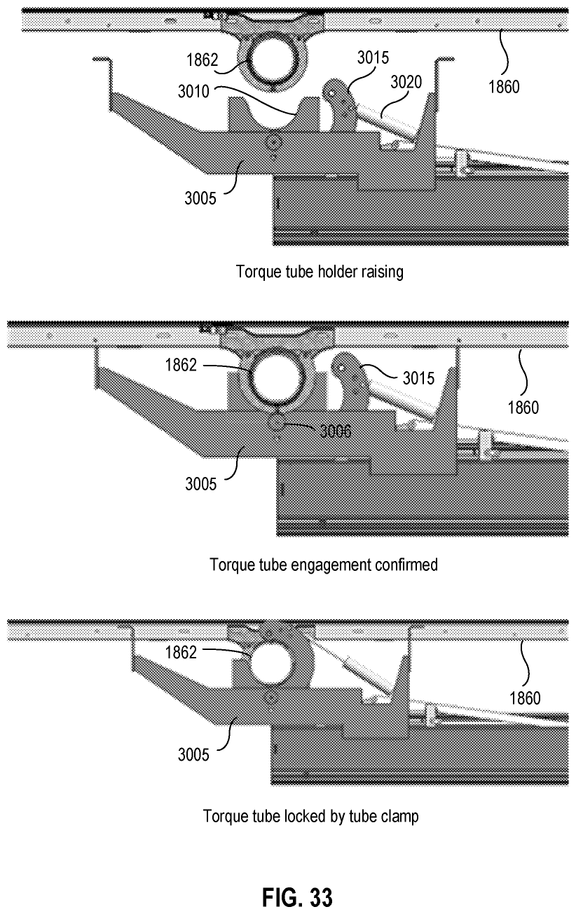

FIG. 33 graphically depicts a process of a torque tube holder holding a torque tube in accordance with various embodiments of the invention. The torque tube holder 3005 moves along a table transfer rail (2914/2916/2924/2926) to a position directly underneath the torque tube 1862 of a solar table 1860, and then moves up, via vertical movement of the transfer section frame 2922 or 2924, to engage the torque tube 1862. Once the torque tube 1862 is contact with the holder base 3010, a pressure sensor 3006 disposed within the holder base 3010 may detect the presence of the torque tube and triggers the clamp actuator 3020 to close the tube clamp 3015, thus locking the torque tube in position. It shall be noted that for the third table transfer section 2930, the solar table is dropped onto the torque tube holders 2936/2938 instead of raising those torque tube holders for torque tube engagements.

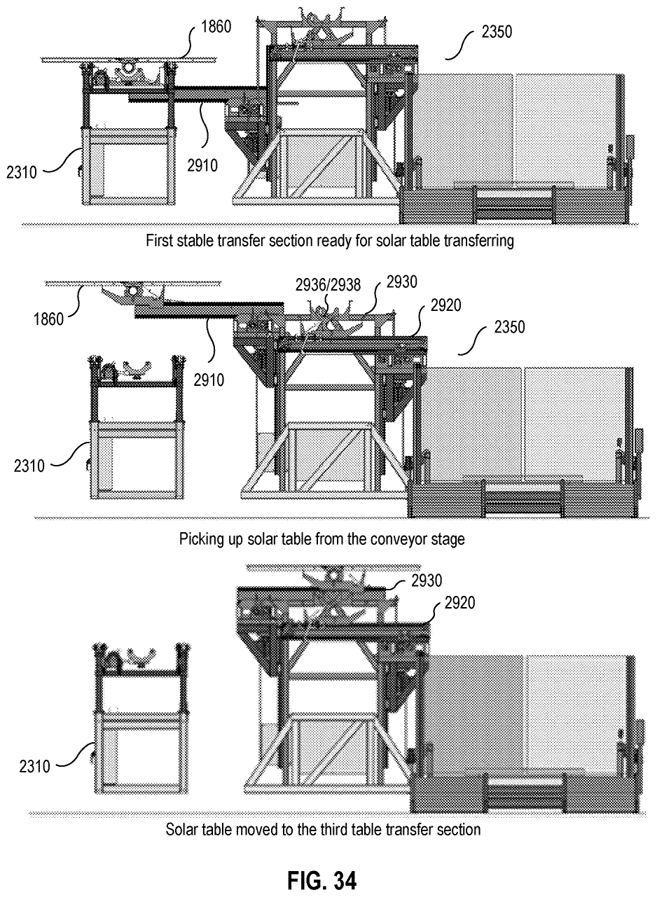

FIG. 34 graphically depicts a process of solar table transferring from a conveyor stage to a table transfer stage and movement within the table transfer stage in accordance with various embodiments of the invention. The first pair of table transfer rails 2914/2916 of the first table transfer section 2910 are extended to the conveyor stage 2310 with corresponding torque tube holders positioned underneath the torque tube of the solar table 1860 ready to start a solar table transferring process. Afterwards, clamp actuators of the torque tube holders are activated to securely hold the torque tube in position and the first table transfer section 2910 is lifted to move the solar table 1860 away from the conveyor stage 2310. The first table transfer section 2910 is lifted to a height with the first pair of table transfer rails 2914/2916 sliding toward the torque tube holders 2936/2938 and transfer the solar table to the third (intermediate) table transfer section 2930.

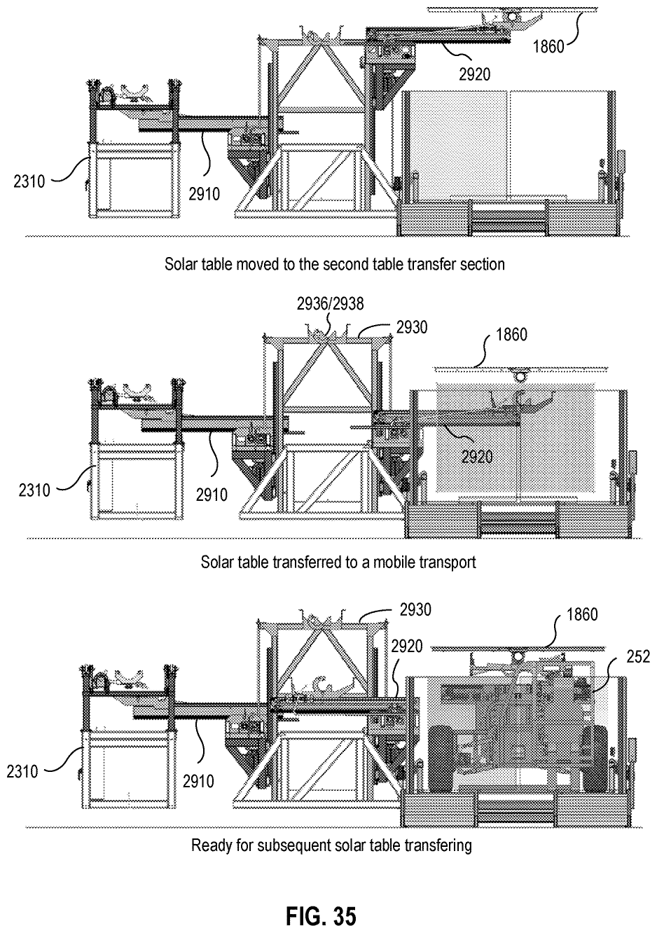

FIG. 35 graphically depicts a process of solar table movement within the table transfer stage and solar table transferring from the table transfer stage to a mobile transport in accordance with various embodiments of the invention. The second table transfer section 2920 is lifted from below the torque tube holders 2936/2938 such that the solar table 1860 is transferred from the third table transfer section 2930 to the second table transfer section 2920. The second pair of table transfer rails 2924/2926 slid toward opposite side of the conveyor stage 2310 and then are lowered to drop the solar table 1860 to a mobile transport 252, which is represented as a grey block in the middle sub-figure of FIG. 35 for clarity of the second table transfer section 2920. Afterwards, the second table transfer section 2920 is moved back to its start position with the second pair of table transfer rails 2924/2926 sliding back to be underneath the third table transfer section 2930 ready for subsequent table transfer operations.

It shall be noted that operations shown in FIGS. 34 and 35 may be performed in parallel. For example, the first table transfer section 2910 may fetch a solar table from the conveyor stage 2310, while in the meantime the second table transfer section 2920 may be operated to drop another solar table to a mobile transport. The multi-sectional configuration of the table transfer stage enables a multiple solar table (e.g., up to three) handling capacity, thus greatly improves solar table offloading efficiency.

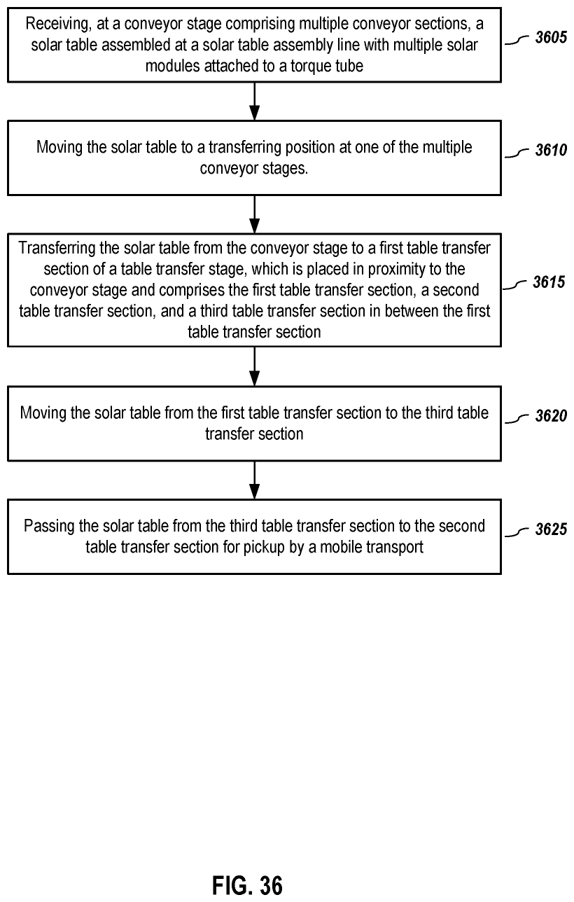

FIG. 36 depicts a process of offloading an assembled solar table from an assembly line in accordance with various embodiments of the invention. It shall be understood that: (1) certain steps may optionally be performed; (2) steps may not be limited to the specific order set forth herein; (3) certain steps may be performed in different orders; and (4) certain steps may be done concurrently.

In step 3605, a solar table, assembled at a solar table assembly line with multiple solar modules attached to a torque tube, is received at a conveyor stage comprising one or more conveyor sections. The conveyor stage is positioned downstream of the assembly line. In step 3610, the solar table is moved within the conveyor stage to a transferring position at one of the multiple conveyor stages. The transferring position may be a position at the second conveyor section 2330 as shown in FIG. 23A. Once the solar table reaches the transferring position, the lock actuators 2532/2534 may be activated to lock the torque tube, thus preventing the solar table from further movement. The lock actuators 2532/2534 may be deactivate later to unlock the torque tube during table transferring from the conveyor stage to the table transfer stage.

In step 3615, the solar table is transferred from the conveyor stage to a first table transfer section of a table transfer stage, which is placed in proximity to the conveyor stage, and comprises the first table transfer section, a second table transfer section, and a third table transfer section in between the first table transfer section.

In step 3620, the solar table is moved from the first table transfer section to the third table transfer section. In this step, the first transfer section frame is raised for the first pair of table transfer rails to be above the pair of support bars of the third table transfer section. Afterwards, the first pair of torque tube holders slide along the first pair of table transfer rails respectively for alignment to the pair of torque tube holders. The first transfer section frame is then lowered for the torque tube of the solar table to be supported by the third pair of torque tube holders. Next, the first pair of torque tube holders are deactivated to release the torque tube and the third pair of torque tube holders are activated to lock the torque tube to complete the table transfer. The first table transfer section may goes back to an original table fetching position in preparation for picking up a subsequent solar table from the conveyor stage.

In step 3625, the solar table is passed from the third table transfer section to the second table transfer section for pickup by a mobile transport. In this step, the second pair of torque tube holders slide along the second pair of table transfer rails respectively for alignment to the pair of torque tube holders. Afterwards, the second transfer section frame is raised for the second pair of torque tube holders to support the torque tube of the solar table. Next, the third pair of torque tube holders are deactivated to release the torque tube, and the second pair of torque tube holders are activated to lock the torque tube to the second table transfer section. The second transfer section frame is then raised again to allow the second pair of torque tube holders slide sideways along the second pair of table transfer rails respectively. Finally, the second transfer section frame is lowered to a height for the solar table to be picked up by a mobile transport.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently, including having multiple dependencies, configurations, and combinations.

What is claimed is:

1. A system for offloading assembled solar tables from assembly line, the system comprising:
a conveyor stage positioned downstream of a solar table assembly line and comprising one or more conveyor sections, the conveyor stage is configured for:
receiving a solar table assembled at the solar table assembly line with multiple solar modules attached to a torque tube;
moving the solar table to a transferring position at one of the multiple conveyor stages; and
a table transfer stage positioned in proximity to the conveyor stage, the table transfer stage comprises multiple table transfer sections; the table transfer stage is configured for:
transferring the solar table from the conveyor stage; and
moving the solar table within the multiple table transfer sections for solar table pickup.

2. The system of claim 1, wherein the one or mroe conveyor sections comprise a first conveyor section, a second conveyor section, and a third conveyor section that are all supported by a conveyor base frame, the second conveyor section has section gaps from the first and third conveyor sections to lift up the solar table through the section gaps for table transferring to the table transfer stage.

3. The system of claim 2, wherein each of the first, second, and third conveyor sections comprises:
a plurality of conveyor couplers for securely coupling to the conveyor base frame;
a pair of belt conveyors longitudinally coupled between the conveyor couplers for solar table support and movement, the pair of belt conveyors are powered together by a conveyor motor for balanced movement;
a pair of module interface bracket (MIB) guide rails with a pair of guide wheels placed respectively on the pair of MIB guide rails to guide torque tube movement; and
a pair of lock actuators coupled respectively to the pair of MIB guide rails for torque tube locking or unlocking.

4. The system of claim 3, wherein the pair of lock actuators are configured to operate synchronically, each lock actuator comprises:
an actuator body;
a fixed end plate coupled to the actuator body;
a moveable end plate coupled to the actuator body; and
a pair of struts coupled between the first end plate and the second end plate;
wherein the lock actuator is pneumatically, hydraulically, or electrically operated to push or retract the moveable end plate.

5. The system of claim 3, wherein each of the first, second, and third conveyor sections further comprises:
a pair of rollers placed on a leading end of the MIB guide rails, respectively;
one or more torque tube supporters placed between the pair of MIB guide rails for additional solar table support and alignment.

6. The system of claim 3, wherein the third conveyor section further comprises:
a safety sensor, comprising an emitter and a receiver, placed near a downstream edge of the pair of MIB guide rails of the third conveyor section, the emitter and the receiver are aligned in position for obstruction detection, the emitter transmits a signal to be received by the receiver;
wherein in response to the solar table being rolled toward the downstream edge of the third conveyor section with the torque tube of the solar table blocking the signal, the receiver sends a trigger signal to the conveyor motor and the pair of lock actuators to stop the belt conveyors and activate the pair of lock actuators, thus preventing the solar table from moving out of third conveyor section and correctly positioning the solar table in relation to the table transfer stage, transporter grabbers and solar table MIBs to avoid interferences; and
a stop plate installed at the edge across the pair of MIB guide rails to prevent the solar table from being rolled out past the edge of the table.

7. The system of claim 2, wherein the multiple table transfer sections comprise:
a first table transfer section facing the conveyor stage;
a second table transfer section; and
a third table transfer section coupled between the first table transfer section and the second table transfer section as a transition section;
wherein the first, second, and third table transfer sections are supported by a table transfer stage base frame, and operate independently or in collaboration for table transfer operation.

8. The system of claim 7, wherein:
the first table transfer section comprising:
a first transfer section frame slidably attached to a first pair of vertical support frames in a vertical direction for height adjustment;
a first pair of table transfer rails attached to the first transfer section frame and extended underneath the section gaps respectively for table transfer;
a first pair of torque tube holders slidably attached to the first pair of table transfer rails respectively, each torque tube holder coupled to a corresponding horizontal rail motor for sliding control along a corresponding table transfer rail; and
the second table transfer section comprising:
a second transfer section frame slidably attached to a second pair of vertical support frames in a vertical direction for height adjustment;
a second pair of table transfer rails attached to the second transfer section frame; and
a second pair of torque tube holders slidably attached to the second pair of table transfer rails respectively, each torque tube holder coupled to a corresponding horizontal rail motor for sliding control along a corresponding table transfer rail; and
wherein the first pair of table transfer rails and the second pair of table transfer rails are offset to avoid operation interference during solar table transferring from the first transfer section toward the second table transfer section.

9. The system of claim 8, wherein each torque tube holder, among the first and second pairs of torque tube holders, comprises:
a holder base coupled to a corresponding table transfer rail;
a tube clamp pivotably coupled to the holder base;
a clamp actuator coupled to the holder clamp to pivot the tube clamp for torque tube lock or release, the clamp actuator is pneumatically, hydraulically, or electrically controlled for extending or retracting, thus closing or opening the tube clamp; and
two anti-rotation wings placed on opposite side of the holder base to prevent rotation of a supported solar table;
wherein each torque tube holder is coupled to a misalignment compensator that is activated to lock the torque tube holder in position or deactivated to allow sliding of the torque tube for horizontal and yaw position adjustment.

10. The system of claim 8, wherein the third table transfer section comprises:
a pair of support bars positioned above the table transfer stage base frame; and
a third pair of torque tube holders fixed on the pair of support bars respectively.

11. A method for offloading assembled solar tables from assembly line, the method comprising:
receiving, at a conveyor stage comprising one or more conveyor sections, a solar table assembled at a solar table assembly line with multiple solar modules attached to a torque tube, the conveyor stage is positioned downstream of the assembly line;
moving the solar table to a transferring position at one of the multiple conveyor stages;
transferring the solar table from the conveyor stage to a table transfer stage positioned in proximity to the conveyor stage, the table transfer stage comprises multiple table transfer sections; and
moving the solar table within the table transfer stage for solar table pickup.

12. The method of claim 11, wherein the one or more conveyor sections comprise a first conveyor section, a second conveyor section, and a third conveyor section that are all supported by a conveyor base frame, the second conveyor section has section gaps from the first and third conveyor sections, the transferring position is a position at the second conveyor section to lift the solar table through the section gaps for table transferring to the table transfer stage.

13. The method of claim 12, wherein each conveyor section comprises:
a plurality of conveyor couplers for securely coupling to the conveyor base frame;
a pair of belt conveyors longitudinally coupled between the conveyor couplers for solar table support and movement, the pair of belt conveyors are powered together by a conveyor motor for balanced movement;
a pair of module interface bracket (MIB) guide rails with a pair of guide wheels placed respectively on the pair of MIB guide rails to guide torque tube movement; and
a pair of lock actuators coupled respectively to the pair of MIB guide rails, the pair of lock actuators are configured to operate synchronically for torque tube locking or unlocking.

14. The method of claim 13, wherein once the solar table reaches the transferring position, the pair of lock actuators at the second conveyor section are activated to lock the torque tube of the solar table to prevent the solar table from further moving, the pair of lock actuators are deactivated to unlock the torque tube during transferring of the solar table from the conveyor stage to the table transfer stage.

15. The method of claim 13 further comprising:
in response to the solar table being moved toward a downstream edge of the third conveyor section with the torque tube of the solar table blocking a receiver from receiving a signal transmitted by an emitter, sending from the receiver a trigger signal to the conveyor motor and the pair of lock actuators to stop the belt conveyors and activate the pair of lock actuators, thus preventing the solar table from moving out of third conveyor section;
wherein the emitter and the receiver are aligned and placed near the downstream edge for obstruction detection.

16. The method of claim 12, wherein the multiple table transfer sections comprise:
a first table transfer section facing the conveyor stage;
a second table transfer section; and
a third table transfer section coupled between the first table transfer section and the second table transfer section as a transition section;
wherein the first, second, and third table transfer sections are supported by a table transfer stage base frame, and operate independently or in collaboration for table transfer operation.

17. The method of claim 16, wherein the first table transfer section comprising:
a first transfer section frame slidably attached to a first pair of vertical support frames in a vertical direction for height adjustment;
a first pair of table transfer rails attached to the first transfer section frame and extended underneath the section gaps respectively for table transfer; and
a first pair of torque tube holders slidably attached to the first pair of table transfer rails respectively, each torque tube holder coupled to a corresponding horizontal rail motor for sliding control along a corresponding table transfer rail.

18. The method of claim 17, wherein the second table transfer section comprising:
a second transfer section frame slidably attached to a second pair of vertical support frames in a vertical direction for height adjustment;
a second pair of table transfer rails attached to the second transfer section frame; and
a second pair of torque tube holders slidably attached to the second pair of table transfer rails respectively, each torque tube holder coupled to a corresponding horizontal rail motor for sliding control along a corresponding table transfer rail; and
wherein the first pair of table transfer rails and the second pair of table transfer rails are offset to avoid operation interference during solar table transferring from the first transfer section toward the second table transfer section.

19. The method of claim 18, wherein moving the solar table within the table transfer stage for solar table pickup comprises steps of:
moving the solar table from the first table transfer section to the third table transfer section, the third table transfer section comprises a pair of support bars positioned above the table transfer stage base frame and a third pair of torque tube holders fixed on the pair of support bars respectively; and
moving the solar table from the third table transfer section to the second table transfer section for solar table pickup.

20. The method of claim 19, wherein moving the solar table from the first table transfer section to the third table transfer section comprises steps of
raising the first transfer section frame for the first pair of table transfer rails to be above the pair of support bars of the third table transfer section;
sliding the first pair of torque tube holders for alignment to the pair of torque tube holders;
lowering the first transfer section frame for the torque tube of the solar table to be supported by the third pair of torque tube holders; and
deactivating the first pair of torque tube holders to release the torque tube; and
activating the third pair of torque tube holders to lock the torque tube.
